(19) United States
(12) Patent Application Publication
(10) Pub. No.: US 2025/0358229 A1
(43) Pub. Date: Nov. 20, 2025

(54) UPLINK AND DOWNLINK DATA PLANE ASPECTS

(71) Applicant: QUALCOMM Incorporated, San Diego, CA (US)

(72) Inventors: Sitaramanjaneyulu Kanamarlapudi, San Diego, CA (US); Arnaud Meylan, San Diego, CA (US); Vamsi Dokku, San Diego, CA (US)

(21) Appl. No.: 19/209,660

(22) Filed: May 15, 2025

Related U.S. Application Data
(60) Provisional application No. 63/649,317, filed on May 17, 2024.
(60) Provisional application No. 63/649,310, filed on May 17, 2024.

(51) Int. Cl. H04L 47/24; H04L 47/12; H04L 47/26; H04L 47/32; H04L 69/28

(52) U.S. Cl. CPC H04L 47/24; H04L 47/12; H04L 47/26; H04L 47/32; H04L 69/28

(57) ABSTRACT

Aspects of the disclosure are directed to downlink data plane aspects of communication. Specifically, communication via low latency, low loss, and scalable throughput (L4S).

### CROSS REFERENCE TO RELATED APPLICATIONS

The present application for patent claims the benefit of U.S. Provisional Application No. 63/649,317, entitled “UPLINK DATA PLANE ASPECTS,” filed May 17, 2024, and U.S. Provisional Application No. 63/649,310, entitled “DOWNLINK DATA PLANE ASPECTS,” filed May 17, 2024, each of which is assigned to the assignee hereof and expressly incorporated herein by reference in its entirety.

### BACKGROUND

### Technical Field

The present disclosure generally relates to communication systems, and more particularly, to uplink and downlink data plane aspects of communications between a user equipment (UE) and a radio access network (RAN).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus for wireless communication, comprising one or more memories, individually or in combination, having instructions, and one or more processors, individually or in combination, configured to execute the instructions. In some examples, the one or more processors are configured to detect latency associated with a packet queued at the apparatus. In some examples, the one or more processors are configured to modify a reordering timer associated with the packet after latency associated with the packet is detected.

Aspects are directed to an apparatus for wireless communication, comprising one or more memories, individually or in combination, having instructions, and one or more processors, individually or in combination, configured to execute the instructions. In some examples, the one or more processors are configured to output a plurality of packets. In some examples, the one or more processors are configured to obtain, after outputting the plurality of packets, an aggregated acknowledgment (ACK) comprising an indication of a latency associated with at least one of the plurality of packets. In some examples, the one or more processors are configured to refrain, for a duration of time, from dropping a packet associated with the aggregated ACK based on the indication of the latency.

Aspects are directed to an apparatus for wireless communication, comprising one or more memories, individually or in combination, having instructions, and one or more processors, individually or in combination, configured to execute the instructions. In some examples, the one or more processors are configured to detect latency associated with a packet queued at the apparatus. In some examples, the one or more processors are configured to set a bit associated with the packet to indicate the detected latency, wherein the bit is set at a data layer of the apparatus.

Aspects are directed to a method for wireless communication. In some examples, the method includes detecting latency associated with a packet queued at the apparatus. In some examples, the method includes modifying a reordering timer associated with the packet after latency associated with the packet is detected.

Aspects are directed to a method for wireless communication. In some examples, the method includes obtaining, after outputting the plurality of packets, an aggregated acknowledgment (ACK) comprising an indication of a latency associated with at least one of the plurality of packets. In some examples, the method includes refraining, for a duration of time, from dropping a packet associated with the aggregated ACK based on the indication of the latency.

Aspects are directed to a method for wireless communication. In some examples, the method includes detecting latency associated with a packet queued at the apparatus. In some examples, the method includes detecting setting a bit associated with the packet to indicate the detected latency, wherein the bit is set at a data layer of the apparatus.

Aspects are directed to an apparatus. In some examples, the apparatus includes means for detecting latency associated with a packet queued at the apparatus. In some examples, the apparatus includes means for modifying a reordering timer associated with the packet after latency associated with the packet is detected.

Aspects are directed to an apparatus. In some examples, the apparatus includes means for obtaining, after outputting the plurality of packets, an aggregated acknowledgment (ACK) comprising an indication of a latency associated with at least one of the plurality of packets. In some examples, the apparatus includes means for refraining, for a duration of time, from dropping a packet associated with the aggregated ACK based on the indication of the latency.

Aspects are directed to an apparatus. In some examples, the apparatus includes means for detecting latency associated with a packet queued at the apparatus. In some examples, the apparatus includes means for detecting setting a bit associated with the packet to indicate the detected latency, wherein the bit is set at a data layer of the apparatus.

Aspects are directed to a non-transitory computer-readable medium comprising instructions that, when executed by a wireless node, cause the wireless node to perform a method. In some examples, the method includes detecting latency associated with a packet queued at the wireless node. In some examples, the method includes modifying a reordering timer associated with the packet after latency associated with the packet is detected.

Aspects are directed to a non-transitory computer-readable medium comprising instructions that, when executed by a wireless node, cause the wireless node to perform a method. In some examples, the method includes obtaining, after outputting the plurality of packets, an aggregated acknowledgment (ACK) comprising an indication of a latency associated with at least one of the plurality of packets. In some examples, the method includes refraining, for a duration of time, from dropping a packet associated with the aggregated ACK based on the indication of the latency.

Aspects are directed to a non-transitory computer-readable medium comprising instructions that, when executed by a wireless node, cause the wireless node to perform a method. In some examples, the method includes detecting latency associated with a packet queued at the wireless node. In some examples, the method includes detecting setting a bit associated with the packet to indicate the detected latency, wherein the bit is set at a data layer of the wireless node.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example of a layer 2 (L2) data flow.

FIG. 6 is a block diagram illustrating an example transmission control protocol (TCP) data flow.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

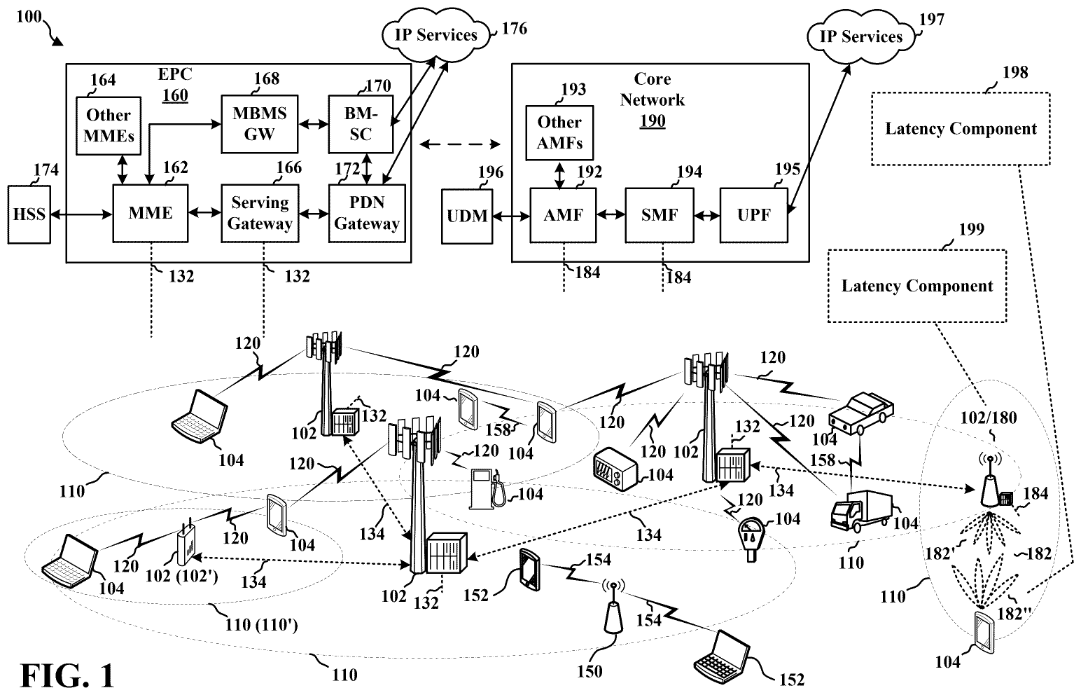

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a latency component 198. As described in more detail elsewhere herein, the latency component 198 may be configured to detect latency associated with a packet queued at the apparatus, and set a bit associated with the packet to indicate the detected latency, wherein the bit is set at a data layer of the apparatus. Additionally, or alternatively, the latency component 198 may perform one or more other operations described herein.

The base station 102/180 may include a latency component 199. As described in more detail elsewhere herein, the latency component 199 may be configured to detect latency associated with a packet queued at the apparatus, and set a bit associated with the packet to indicate the detected latency, wherein the bit is set at a data layer of the apparatus. Additionally, or alternatively, the latency component 199 may perform one or more other operations described herein.

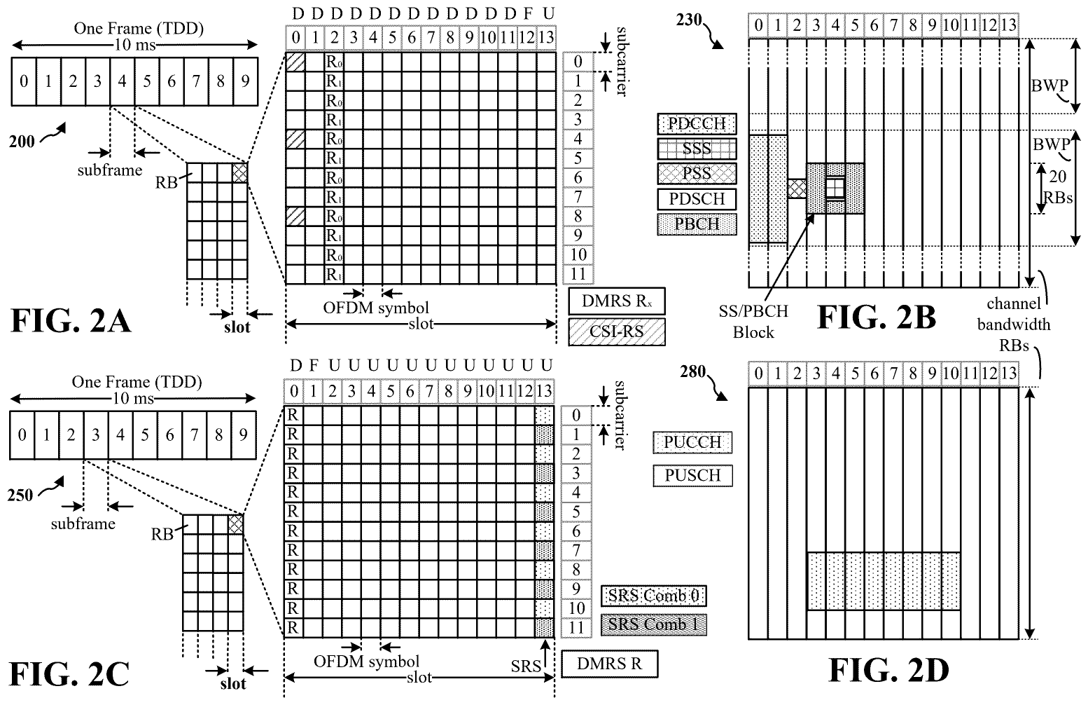

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

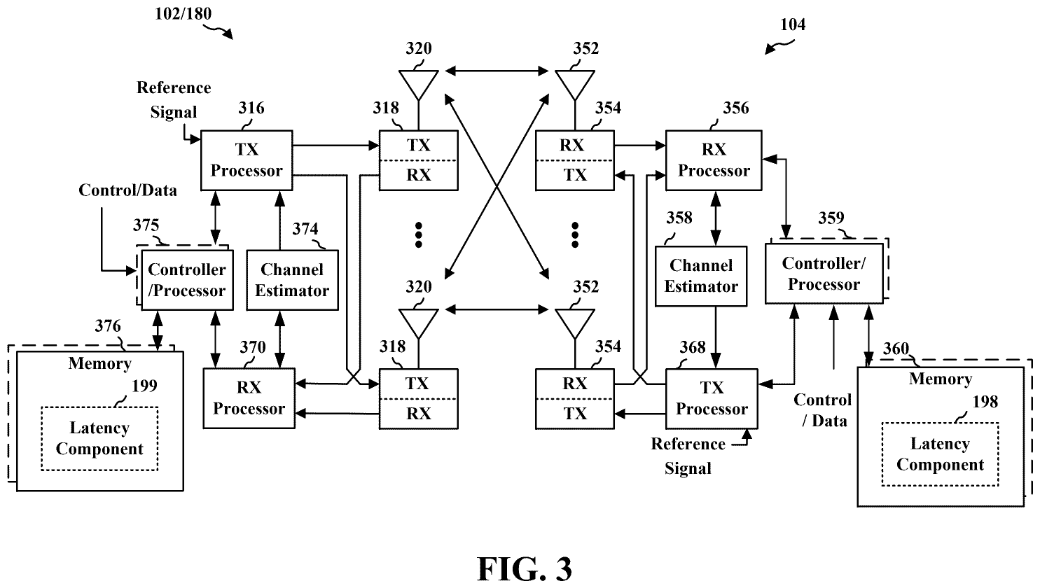

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

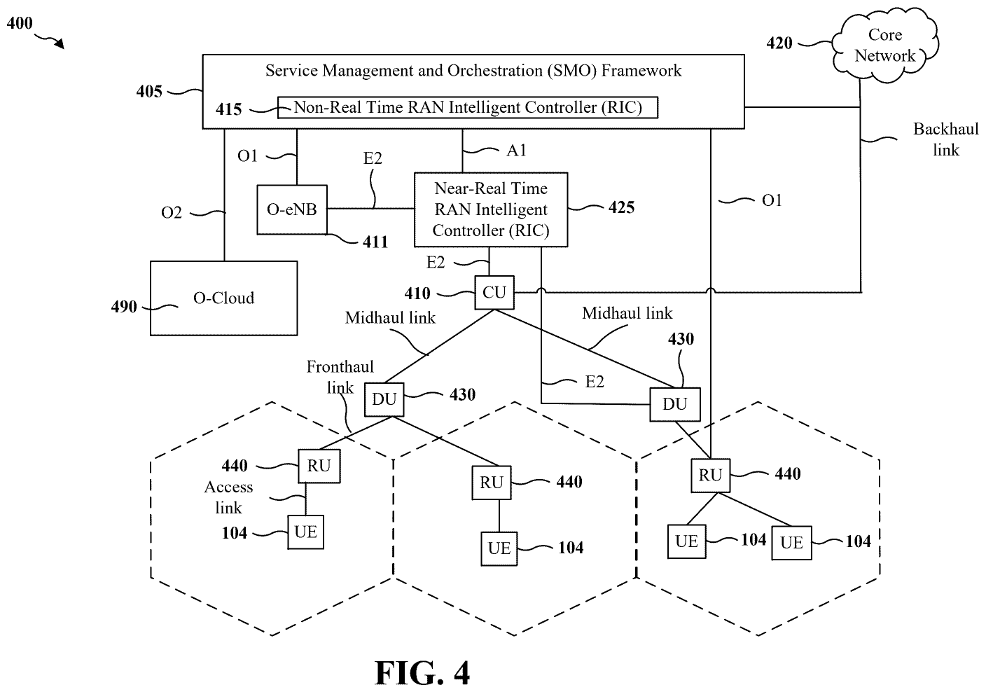

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the El interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as Al policies).

### Examples of Low-Latency, Low-Loss, Scalable Throughput (L4S) Communications

The L4S protocol is a network technology designed to enhance the performance of internet traffic by reducing latency and packet loss while maintaining high throughput. It achieves this by using a more advanced congestion control mechanism that allows for faster and more efficient data transmission. Unlike traditional protocols, which can experience significant delays and packet loss during high traffic periods, L4S is configured to handle congestion more gracefully, ensuring smoother and more responsive internet experiences. This is particularly beneficial for applications that require real-time data transmission, such as online gaming, video conferencing, and virtual reality.

The key difference between L4S and non-L4S protocols lies in their approach to managing network congestion. Non-L4S protocols typically use methods like TCP's congestion control, which can lead to increased latency and packet loss as the network becomes congested. These traditional methods often involve slowing down data transmission to prevent congestion, which can degrade performance. In contrast, L4S uses a more sophisticated approach that allows for continuous data flow even under congested conditions, minimizing delays and packet loss. This is achieved through techniques like explicit congestion notification (ECN) marking, which provides feedback to the sender about the network's state, allowing for dynamic adjustments to the transmission rate. As a result, L4S can deliver a more consistent and reliable internet experience, especially in environments where low latency is crucial.

Conventional data requirements for user experience may be based on well-defined key performance indicators (KPI) linked to throughput, latency and packet loss. Transmission control protocol (TCP) is one of the main protocols in the internet protocol suite, and it sits at the same layer as the internet Protocol (IP), together often referred to as TCP/IP. TCP congestion algorithms may handle scaling aspects of traffic based on throughput, latency and/or packet loss, and variants of these algorithms may be configured to address different segments and market needs based on traffic patterns and topology of a given network.

Quick UDP internet connections (QUIC) relates to a transport layer protocol developed to improve the performance of web applications by decreasing latency compared to that of TCP. In some examples, QUIC achieves faster connection establishment by introducing a connection identifier and combining the connection and security handshakes into a single step, which reduces the time it takes to establish a secure connection. It's built on top of user datagram protocol (UDP) instead of TCP, which allows it to bypass some of the limitations of TCP. QUIC also offers improved congestion control, forward error correction, and handling of packet loss, all of which can contribute to better performance for real-time streaming applications and web browsing. Thus, QUIC addresses head-of-line blocking (HOLB) aspects to improve throughput and packet loss. However, despite these advantages, latency may continue to be a challenge.

For example, with relatively higher bandwidth links both at backhaul and on radio networks to address specific link issues, latency and packet loss continue to present problems for communications due to the many various application traffic requirements and despite attempts by congestion algorithms to adapt. In some examples, latency may negatively affect round trip time (RTT) and result in packet drop due to buffer buildup at some link/point in an end-to-end (E2E) network between, for example, an application server or IP service and a user.

With the addition of extended reality (XR) type verticals (e.g., technologies and applications that use XR technologies), where latency is a top priority for an enhanced and immersive user experience, there is a need to develop techniques for reducing latency. For example, haptic traffic (e.g., data and signals associated with tactile sensations) has latency requirements typically being sub-5 ms (relative to video gaming latency requirements of sub-30 ms). Reducing latency in time-critical, time-sensitive networking (TSN) is also a priority in, for example, industrial implementations and mixed-traffic communications (e.g., Zoom call and simultaneous file upload/download as part of applications usage) and other scenarios that include differential behavior of traffic characteristics.

In summary, varying traffic loading and buffer management issues can result in increased queuing delay or packet loss which existing TCP congestion algorithms often fail to address. For example, existing TCP congestion algorithms are often incapable of traffic loading and buffer management in a manner that account for IP traffic being routed through various intermittent nodes. To address the short comings of existing TCP congestion algorithms, L4S protocol may be implemented with some variations to the architecture of the TCP protocol and congestion management techniques, with fallback to a mechanism to coexist rather that use completely different protocol.

In certain aspects, the L4S protocol may be configured to mark packets with ECN info at a link level if some buffer build up or congestion in the link is detected. This marking enables a receiver to determine an interval and/or a quantity of packets that are affected by queuing issues, and provide the feedback to the transmitter via “aggregated ECN” info to adapt the rate at the transmitter.

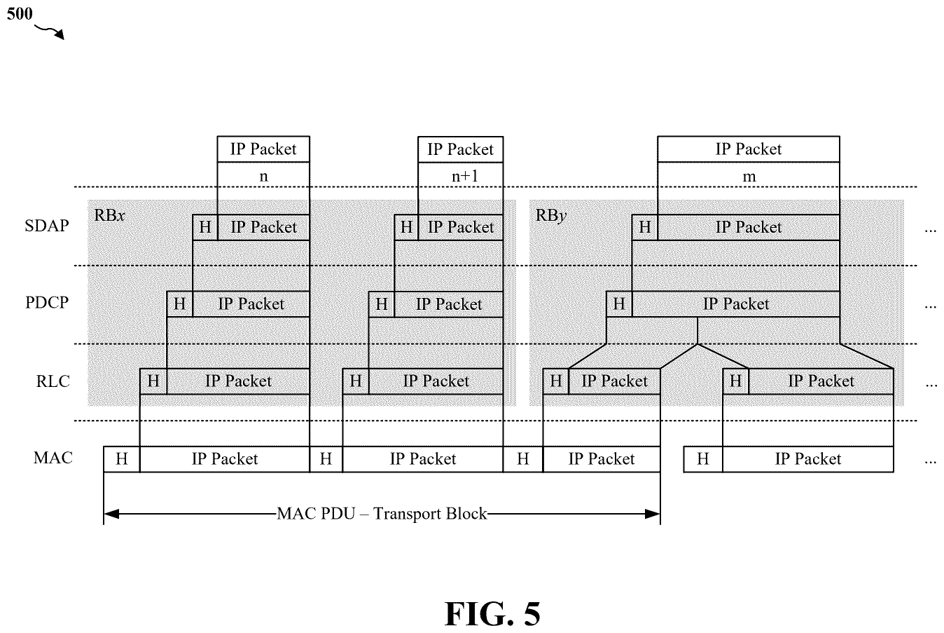

FIG. 5 is a block diagram illustrating an example of a layer 2 (L2) data flow. As illustrated, resource blocks (RBs) form a foundation of an L2 data flow, which are the smallest units of data transmission in wireless communications. Central to the data flow are IP packets, which are units of data containing routing information and payloads. These packets are processed through various layers to reach their destination. For example, the IP packets may be routed through a service data adaptation protocol (SDAP) layer which maps the IP packets to appropriate quality of service (QOS) flows, ensuring data is transmitted with the correct priority for different applications.

The packet data convergence protocol (PDCP) layer handles compression and encryption, maintaining data integrity and security by reducing overhead and protecting data from unauthorized access. It also manages retransmissions in case of packet loss. The radio link control (RLC) layer is configured to handle error correction and data segmentation, breaking down large packets into smaller segments for transmission and reassembling them at the receiving end, while also managing retransmissions and error correction. Finally, the medium access control (MAC) layer controls access to the physical transmission medium, scheduling data transmission, managing resource allocation, and handling collision avoidance to ensure efficient data transmission and resource sharing among users. Together, these layers and components form a complex system that facilitates the seamless delivery of data across wireless networks.

Internet protocol (IP) operates at a higher layer in the network stack, specifically at the network layer (e.g., layer 3) of the OSI model. IP is responsible for delivering packets from a source device to a destination device based on IP addresses in the packet headers (illustrated as “H”). In a 5G NR network, the IP packets are passed down from the network layer to a transport layer (e.g., layer 4), where protocols like TCP or UDP operate. After that, they are passed down to a data link layer (e.g., layer 2), where the above-mentioned protocols (SDAP, PDCP, RLC, MAC) function.

The PDCP at layer 2 is the layer that directly interacts with IP packets. It receives the IP packets from the upper layer, performs operations like header compression to reduce the size of the IP headers, and then passes them to the lower layers for transmission.

It should be noted, low latency is not provided by the network; rather, low latency may be a result of scalable congestion controllers used by L4S senders. Such controllers may use ECN protocol by signaling the start of queue growth immediately, without the smoothing delay typical of conventional active queue management (AQM). Because ECN support is essential for L4S, wireless nodes may use an ECN field to allow the network to identify which packets are L4S and which are not. A transmitting device may distinguish L4S and non-L4S packets with an identifier so that the network can classify them and treat them according to their unique requirements.

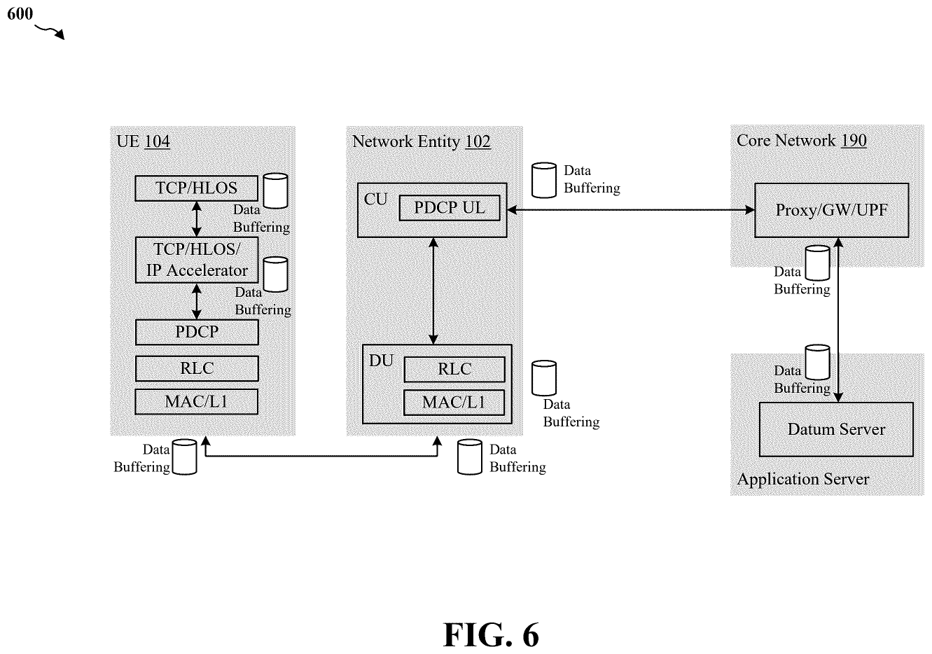

However, latency problems still exist with L4S protocol. While the L4S protocol addresses IP Data transmission as well as congestion aspects to improve traffic flow KPIs in an IP Network, latency issues associated with queueing delay still exist within the radio environment, for example in RAN network architecture and UE architecture. FIG. 6 is a block diagram illustrating an example TCP data flow 600. As illustrated, various data buffers exist throughout the E2E pipeline. Such buffering between the RAN node(s) and UE may be improved to reduce latency.

Regarding downlink communications: links between an application server and UPF in the radio network, and links between the UPF and a network entity may be IP based links that do not use any form of flow control. However, data communicated via these links may be passed between nodes that may limit the flow based on routing rules and link capacity. Moreover, although the IP packet may be communicated via various radio protocols, the IP packet may not be modified within radio protocol layers to address L4S protocol aspects.

Even after sending the BSR successfully, uplink communications may be delayed due to radio conditions and network scheduling policies for the UE. In some examples, such factors may increase the overall delay and packet loss. As IP packets enter a PDCP input queue, they may be encoded as part of the PDCP PDU. In some examples, the PDCP input queue may perform ciphering and integrity protection to ensure security aspects, which means PDCP contents may be modified later. Although such security aspects on the radio link are implemented to avoid a range of security issues and so-called “man-in-the-middle” attacks, these security aspects may still introduce delays. Additional delays and packet loss/recovery characteristics (e.g., RLC ARQ, HARQ ReTx) may also impact the overall latency from an application data perspective.

In some examples, a CU PDCP layer may move the packet over the NR-U link to DU for RLC level protocol handling and subsequent MAC scheduling to transmit over the air (OTA). The NR-U link may operate based on the GTP-U based with “status-retransmission” to ensure all the packets are successfully received at DU.

Regarding uplink communications: an application operating on a UE may transmit data to a UE modem via various interconnect mechanisms (e.g., shared memory, USB, PCIe, hardware (HW) accelerators, and the like.). Once data enters a PDCP queue, it may be reported as part of a data volume reporting via a MAC buffer status report (BSR) transmitted to a network entity via a request for UL Grant. In some examples, it may be reported via a scheduling request (SR) or random-access channel (RACH) message, depending on the UE state.

The UE and/or network entity may contribute to latency of downlink communications several different way, for example: (1) there is no flow control on the NG-U link, due to which UPF may push a maximum amount of data possible to a network entity when the link is active. However, because UE buffers may be controlled under a RAN policy, packets can be discarded due to a buffer full event. (2) Downlink scheduling and buffering policies of a UE may directly or indirectly cause a form of flow control (e.g., which may control how much data can arrive from CU to DU) on the NR-U link. Such policies may result in delayed and/or bursty flow behavior on the NR-U link. (3) In some examples, there may be packet delays at the MAC level due to one or more of: scheduling delays, system level loading issues at the RAN, policy-based rules, UE channel conditions, and/or other radio and data plane aspects. (4) Packet delays due to HARQ BLER resulting in multiple HARQs to recover. (5) Packet delays due to RLC ARQ resulting in retransmission and associated delays at PDCP reordering queue level. (6) Packet delays due to scheduling policy and operating radio conditions in terms of Grant size, MCS, UE reported CSI information, etc.

Similarly, several scenarios in uplink communication from UE to a network entity may contribute to such latency: (1) UL Packet delays at PDCP level itself due to SR or RACH procedure latency based on the UE connection state and NW configuration. (2) UL Packet delays at BSR procedure latency to indicate the request to NW. (3) UL packet delays due to UL grant assignment from NW, based on scheduling policy. (4) UL packet delays due to HARQ BLER resulting in multiple HARQs to recover. (5) UL packet delays due to RLC ARQ resulting in retransmission and associated delays at PDCP reordering queue level. (6) UL packet delays due to RB mapping and associated LCP rules which may limit the amount of data which can be transmitted from that LC based on priority, BSD/PBR, and the like. (7) UL packet delays due to scheduling policy and operating radio conditions in terms of grant size, MCS, available power head room, etc. Also, (8) network-side UL PDCP reordering delays. For instance, in a dual cell scenario, one primary leg may perform fine, while the secondary leg experiences delays, as a result the whole bearer experiences delay.

All these delays may result in latency due to packet loss based on: (i) various aspects of the buffering policy at NW/UE and its capabilities, and (ii) configuration parameters like PDCP discard timer from a transmitter side, PDCP reordering timer from a receiver side, RLC reTx/polling/status triggers, HARQ configuration as well as buffer overload policies may contribute to packet loss and latency. Moreover, because IP aspects of the packet cease or are removed after the PDCP PDU encoding (due to cipher/integrity aspects), even with the additional queueing latency issues identified, packets cannot be modified/marked with ECN to fulfill L4S.

Because cellular implementations typically use PDCP in-sequence delivery, there are different ways which may cause packets to experience delay. For example, (i) on a given radio link, apart from the packets which are going through reTx and experiencing higher latency, all other packets which are successfully received and waiting in the PDCP reordering queue will experience the additional latency (all the packets will experience worst case latency of the last packet reception to enable the in-sequence delivery or timer reordering expiry). These delays can be due to radio link level BLER or CC level BLER or slot level BLER or specific to MCS level. (ii) In dual connected mode of operation (NR-DC/EN-DC), as different PDCP packets take different radio connections (LTE vs NR, FR1 vs FR2), associated additional delay/loss also can contribute for more number of packets being in the waiting mode at PDCP reordering level.

Thus, aspects of the disclosure are directed to techniques and methods for extending the L4S concepts to cellular radio architecture and addressing queuing delay and buffer handling aspects related to latency at both the UE and network entity. Such aspects are directed to enhancing E2E application level KPIs to improve the SLA (service level agreement) aspects of a given application. Aspects of the disclosure are also directed to uplink and downlink data plane aspects in modems used by the UE and network.

### Examples of UE-Side Uplink and Downlink Data Plane Aspects

Aspects are directed to data plane aspects of end-to-end L4S concepts. This may include determining, by the network entity and/or UE, when congestion happens and indicating the congestion in an IP header. This part is typically done by the routers in the IP protocol level, which is the expectation of the RFC. However, once a device gets into a PDCP packet, the IP domain qualities may be lost. Thus, even when the data is in the radio protocol or data plane, a device may identify the congestion situation and mark the ECN header.

The UE modem may act as a concentration point, gathering flows from various hosts and clients. For example, when a UE is operated, multiple flows associated with multiple services and/or applications may exist. The different flows may be serviced differently based on the various subscriptions, sessions, bearers, priority, video protocols, etc. associated with corresponding flows.

The level of where the latency condition is determined may determine what level of fairness is applied at the UE. For example, a wireless device may determine the level at which a condition causing latency exists, so that the device can mark the ECN at that level. The UE may determine when congestion happens and indicate the congestion in an ECN field of an IP header of a packet. It should be noted that the ECN bit may be set at any of the IP level, SDAP level, PDCP level, RLC level, and MAC level. For example, if a PDCP packet is delayed, then the UE or UE's modem may set the bit at the PDCP level. Since the bit is set at the PDCP level, the packet may be cyphered again. The UE/modem may act as a concentration point, gathering flows from various hosts/clients, and servicing them using various subscriptions, PDU sessions, bearers, priority queues. The level where congestion is determined determines at what level fairness is applied, and the UE/modem has several options, for example: (1) at the UE-level: sum of all the bearers or all subs. Here, the UE may detect congestion or queueing delay based on monitoring all radio bearers and/or subscriptions operating on the UE; (2) at the “host/client” level. Here, the UE may monitor individual data flows, bearers, and/or subscriptions based on, for example, the monitored flow(s) being a relatively high priority flow; (3) at the subscription level: sum of all the bearers for this subscription. In a multi-SIM example, the UE may monitor traffic flows, radio bearers, subscriptions associated with one or more SIMs; (4) at the PDN level: the UE may monitor one or more bearers associated with a PDN; (5) at the bearer level: the UE may monitor one or more the flows of a particular one or more radio bearers; (6) at the priority-queue level of a bearer: the UE may monitor one or more bearers based on priority or other communication metric; and/or (7) latency may be detected by a UE by monitoring which flows get ECN congestion marked when a downlink or uplink communication is determined to be experiencing congestion. Thus, in certain aspects, if the UE detects downlink and/or uplink congestion, the UE may mark packets that are part of flows associated with that UE.

In certain aspects, the UE may request, control (e.g., override), and/or negotiate an override of a default PDCP reordering timer for L4S specific data flows. In some examples, the requesting, controlling, and/or negotiating for L4S data flows may be performed differently than such operations would be performed for non-L4S flows. In some examples, the requesting, controlling, and/or negotiating for L4S data flows may be based on the buffering aspects, importance of the traffic (e.g., ECN marked packets may be treated as high importance) or for non-L4S traffic based on total outstanding buffer. This value can be custom to specific flows or triggering events.

For example, the UE may request, control, or negotiate the PDCP reordering timer based on the type of traffic (e.g., which is known to the data domain). Based on this, a duration of a PDCP reordering timer may be adjusted at the PDCP level based on one or more of: the data domain knowledge of the type of traffic (e.g., L4S traffic vs non-L4S traffic) and/or the type of markings (e.g., ECN) of packets associated with the traffic.

In some examples, the UE may request, control, or negotiate the PDCP reordering timer for a particular radio bearer, a particular flow of a radio bearer, and/or based on a triggering event. The UE may override the PDCP reordering timer at the bearer level, an application flow (app flow) level, or based on specific triggering events. In one example, a triggering event may relate to whether a packet has an ECN bit that has been marked to indicate congestion. If the packet has the marked ECN bit, then the UE may be triggered to reduce the PDCP reordering timer for a duration of time, whereas if the packet does not have an ECN marking, the UE may not attempt to adjust the PDCP timer. For example, if a packet with an ECN bit set is detected in a particular flow, the UE may respond by reducing the PDCP reordering timer from 500 ms to 50 ms, for a duration of 100 ms. It should be noted that the foregoing values are examples, and any suitable value may be used.

In certain aspects, when “aggregated ECN” feedback information is received via downlink TCP ACK (or other protocol feedback), the UE may refrain, for a duration of time, from dropping any TCP ACK packets in order to preserve (e.g., not drop) packets associated with the aggregated ECN. For example, in some scenarios, a UE may drop ACK packets to preserve downlink resources in the modem. However, the UE may override this behavior to preserve ECN packets. In some examples, the UE may refrain from dropping any TCP ACK packets for a duration of time. The duration of time may be any suitable length of time, and the duration of time may be (pre-) configured at the UE or by a network entity. It should be noted that an aggregated ACK may refer to a process where multiple ACK messages are combined and sent as a single message.

For example, the UE may transmit L4S packets via uplink to a network entity, and in response, the UE may receive an aggregated ACK containing ECN feedback information associated with the transmitted packets. Because the ECN feedback information may be carried by any of the packets used to transmit the aggregated ACK, the UE may refrain from dropping any of the aggregated ACK packets.

In certain aspects, a network entity may refrain from combining or coalescing downlink packets with ECN information (e.g., packets with an ECN bit set to indicate traffic congestion) when they are communicated between different entities (e.g., CU, DU, core network, application server, etc.) or to accommodate the larger IP Size compared to over the air (OTA) maximum transmission unit (MTU) size, to improve the Application-level processing gains. In some examples, the UE may refrain from combining or coalescing downlink packets with ECN information for a duration of time. The duration of time may be any suitable length of time, and the duration of time may be (pre-) configured at the UE or by a network entity.

Coalescing or aggregation, like in a retransmission scheduling coalescing (RSC) or retransmission scheduling bundling (RSB), is a process used in networking to improve efficiency. Such processes may combine several smaller packets into a larger package to reduce overhead associated with transmitting each packet individually. In some examples, when a packet is lost or corrupted during transmission, the receiver may request a retransmission. With RSC or RSB, instead of immediately retransmitting the lost packet, the transmitter may wait for a duration of time to see if there are more lost packets. If there are, it may bundle the lost packets together for retransmission, thereby reducing the overhead and improving the efficiency of the retransmission process.

For example, a modem or chipset may be capable of communicating at 10 GB per second, or 1.25 megabytes per millisecond (ms). However, the OTA MTA (e.g., the maximum size of a data packet that can be transmitted) packet size may be 1.5 kilobytes. In this example, about 1000 packets may need to be processed by a receiver in order to avoid the 8000 packets that would need to be processed individually. Thus, because an IP packet has a payload field length of 16 bits (e.g., meaning an IP packet may carry up to 64 kilobytes), a transmitter may combine 40 IP packets (each being 1.5 kilobytes) into a 60 kilobyte IP packet, then provide the 60 kilobyte IP packet to a receiver (e.g., an application processor). In other words, the original 8000 packets become only 200 larger packets to be processed at the receiver, thereby reducing processing overhead.

Accordingly, the UE may refrain from performing any packet coalescing or aggregation when one or more of the packets have an ECN bit set to indicate congestion. For example, if each of the original 8000 packets have their respective ECN bits set, and those packets are coalesced into 200 larger packets, then the application processor may interpret this as 200 packets with ECN bits set instead of 8000 packets with ECN bits set.

In certain aspects, in PDU Set based configurations (e.g., XR) may be defined by PDU Set Metrics (e.g., PSDB, PSER, PSI, PSIHI).

In some examples, the UE data plane may mark ECN bits of packets when PSI based PDU discard is ready to be exercised with the network-based congestion handling seen at a radio protocol level. For example, if the UE determines that the network dropped P-frames and only transmitted I-frames. For instance, an I-frame may be configured with higher priority relative to a P-frame, and P-frame is dropped with an explicit congestion notification from the network.

In one example, if there is a congestion condition over the radio between the UE and a network entity, the network entity may transmit an indication notifying the UE that the radio link between the UE and the network entity is in congested mode, and that for the uplink traffic UE can discard some packets that are of low importance. However, this indication may imply that the network entity will also drop some downlink packets due to the congestion. Although the indication may not explicitly tell the UE that the network entity may drop packets, the UE may detect network entity packet drop if it only receives I-frames or receives consecutive I-frame packets with no P-frames in-between the I-frames.

Thus, in some examples, if the UE receives an indication of a congestion condition, and the UE begins receiving consecutive I-frames, the UE may set the ECN bits of the received I-frame packets to indicate (e.g., to the application processor) that there is a congestion condition and/or that the UE did not receive one or more P-frames from the network entity (e.g., the network entity dropped or did not transmit the P-frames).

In another example, UE Data plane can mark specific packets with ECN, when specific packets are lost in the PDU Set even though PSIHI indicates that not all packets are necessary and indicated from PDCP to Data layers. PSIHI may indicate whether all the packets are needed or not in the PDU Set for successful decoding based on level of CRC or FEC techniques (redundant packets along with systematic packets).

For example, PSIHI may indicate that, out of the 200 packets, the application processor needs a minimum of 180 packets. Thus, if the UE receives only 180 packets but expects 200, the UE may determine that 20 packets have been lost. Thus, the UE may set the ECN bits of the 180 packets before passing those packets to the application processor. Even though PSIHI indicates that the 20 packet loss is acceptable, the ECN bits may still be set because the ECN bits may indicate whether the FEC is no longer required, and may result in removing the FEC. But in some examples, if packets are lost, then FEC may continue to be used.

In multi-modal association between flows (e.g., Video, Audio, Haptic), which in combination provide an immersive experience to an application user, when one flow gets delayed other associated flows can be marked with ECN. In some examples, the UE may set the ECN bits of the received packets while handling the packets in the Data domain (data plane) after the packets have been delivered from the PDCP reordering queue. The UE may detect that packets associated with a particular flow are delayed based on a QFI metric that associated packets of different flows.

For example, in such a multi-modal association, all the video, audio, haptic, etc. flows have to be synced in together in order to provide an acceptable user experience. This may be referred to as a “multi modal association.” Thus, when one flow gets delayed, the UE may mark received packets of the flow(s) not delayed. In some examples, the received packets that are not delayed may be marked ECN to indicate an association between those packets and the delayed packets because they all need to be played together.

In another example, while handling PDCP SN packets, the UE data plane may mark the ECN bits associated with those packets when previous packets are discarded. The network entity may notify the UE that previous packets are discarded explicitly via a control PDU.

For example, a network entity may transmit packets 1-5 to the UE, but the UE may only receive packets 1-3. Thus, packets four and five may have been discarded by the network entity. Then, the network entity may transmit packets 6-8 to the UE. In this example, the UE may either wait for retransmission of packets 4 and 5, or the network may transmit an explicit indication notifying the UE not to wait for packets 4 and 5. Thus, the UE may mark the ECN bits of packets 6-8 to indicate that packets 4 and 5 are lost on the network side (which may be indicated by the control PDU).

In some examples, a UE WWAN link may be used as a backhaul for a router. Router clients may include: (i) a smartphone with an HLOS on an application processor, (ii) a WLAN Access point serving clients of a Wi-Fi hotspot, (iii) an Ethernet card serving Ethernet clients, and/or (iv) a USB port serving clients over USB. In some cases, the WWAN link may be faster than the link towards the clients, cause a buffer build up at the ingress of the link to the client (e.g., SOC, PCIe, WLAN, Ethernet, USB). Each of these technologies and or the modem may handle L4S dedicated queue and mark the traffic.

For example, the UE may be operating like a backhaul connected to a Wi-Fi router, but the Wi-Fi router is accepting data from the UE relatively slowly because the router does not have a bandwidth that matches the UEs capability. Thus, the UE's data buffer may accumulate data waiting to be transmitted to the router. In this example, the UE may mark a packet waiting in the buffer if the duration of time that the packet spends in the buffer satisfies a threshold condition. Accordingly, depending on how much time the packet is buffered, the UE may the ECN bits of that packet because the amount of data being buffered is adding the to the latency of end to end traffic between the UE and router.

In certain aspects, if the UE detects congestion, the UE may mark packets that are part of flows of that UE. However, in some examples, the UE may mark based on different rules or parameters. As discussed above at (1-7), ECN marking may occur at various levels within the UE.

For example, (1) may relate to all the uplink traffic that flows through the UE. In some examples, a UE and/or its modem may have multiple clients to which it is connected. For example, clients may include HLOS (e.g., android), WiFi clients, tethered clients, clients established via ethernet. Here, a traffic flow with the HLOS client may be relatively slow, meaning that an associated buffer is not filling up. Thus, the UE may not mark ECN packets associated with the HLOS client. But traffic from a WiFi hotspot may be relatively fast, and filling up associated buffers. Thus, at the Wi-Fi hotspot level, the UE may mark the ECN field of packets for the WiFi hotspot client. In other words, the UE may mark packets at different levels or layers, depending on implementation of (1-7) above.

Another option discussed is the PDN level. Different PDNs may include a PDN for Internet access, another PDN for service like IMS, voice, text, etc. The UE may set ECN bits at the PDN level, wherein any threshold condition for marking the ECN bits may be the same across all PDNs, or specific to a particular PDN or group of PDNs. Because different PDNs may be associated with different rules, services, etc., the UE may set ECN bits of packets associated with different PDNs based on different threshold conditions associated with each PDN. Similarly, the UE may set ECN bits at the bearer level, wherein any threshold condition for marking the ECN bits may be the same across all bearers, or specific to a particular bearer or group of bearers. In one example, there may be no congestion at a first queue associated with a first bearer, whereas there is congestion at a second queue associated with a second bearer. Thus, the UE may set ECN bits of packets of the second bearer but not the first bearer.

In another example, an Internet bearer may be associated with multiple queues each having a different priority. Thus, setting the ECN bit of a packet may be based on which queue the packets is associated. In other words, the marking of the ECN packet may be different depending on the queue and priority associated with the queue.

In certain aspects, the UE may detect congestion, and in response to the congestion, the UE may set the ECN of a congested packet before the packet is passed to the PDCP layer. In other words, the data domain may be configured to detect a radio congestion situation.

In certain aspects, the UE may detect congestion if the content of an UL queue (e.g., PDCP UL queue or total data yet to be transmitted for the first time or total data yet to be successfully acknowledged by receiver) built up in a modem of the UE satisfies a threshold condition. For example, 100 kilobytes of data may already be buffered in the PDCP. Here, a threshold condition is met when the buffered data at the PDCP is equal to or greater than 100 KB. Thus, while the threshold condition is met, any data that the UE is going to enqueue into the PDCP, the UE may mark with L4S ECN.

In some examples, the UE modem may mark the packets. In another example, the marking may occur at the application processor of the UE. Here, the UE may indicate to the application processor that it is to mark packets while the threshold condition is satisfied. When the threshold condition is no longer satisfied, the UE may indicate to the application processor that it no longer needs to mark packets.

In another example, based on whether the PDCP queue satisfies a threshold condition, the UE may use an interconnect (e.g., IPA HW illustrated between application processor (TCP/HLOS) and the modem) between the application processor of the UE and a modem of the UE to set the ECN bit of a packet. In another example, the modem's data plane (e.g., IP accelerator software prior to the PDCP layer) may set the ECN bit of the packet if the threshold condition is satisfied. Thus, the UE may notify one or more of the application processor, the interconnect, and/or the data plane within the modem to set ECN bits of packets while the threshold condition is satisfied.

In some examples, the UE may compare the effective data throughput on a bearer with an RRC configured guaranteed bit rate (GBR) or prioritized bit rate (PBR). Here, a threshold condition may be satisfied if a GBR and/or PBR value, when multiplied by a weight (e.g., an integer) is equal to or greater than a threshold value (e.g., another integer). Such a threshold may be applied on a per bearer basis, or a common threshold may be used across all bearers. In some examples, the threshold value may be a function of a GBR/PBR value associated with a particular bearer.

For example, a UE may be configured to send at 100 MB per second on a bearer, but due to scheduling, congestion, or other radio conditions, the UE may be limited to transmitting less data (e.g., 50 MB per second) even when the data is available for uplink transmission. Here, the UE may detect congestion based on the weighted GBR/PBR, which may trigger the UE to starting marking ECN bits of packets.

In certain aspects, the UE may begin marking ECN bits of packets based on a queuing time in the UE modem (e.g., at a level associated with any of (1-7) discussed above). However, a queue size may not always be an ideal indicator of latency because it depends on air interface speed, which may vary significantly based on many different factors in a wireless system. For example, an allocated bandwidth for uplink transmissions may be ample for transmitting packets associated with a first bearer, but a second bearer having a higher priority may prevent the transmission of packets associated with the first bearer. In this example, the packets associated with the first bearer may spend more time in the queue. If the amount of time that a packet spends in a queue is equal to or greater than a threshold condition, then the UE may begin setting ECN bits of packets in that queue.

In certain aspects, when “aggregated ECN” feedback information is transmitted in uplink through TCP ACK (or other protocol feedback), the UE may determine not to drop any TCP ACK packet to reduce UL bandwidth in modem. When packets with ECN bits set are received by a device (e.g., UE or network entity), the device may count how many packets have ECN bits set. The client may send the count (e.g., aggregated ECN information) to the application server. In an uplink transmission, the aggregated ECN information may be a part of a TCP ACK, or a part of an RTP feedback, or any other suitable communication based on protocols. In some examples, when TCP ACK packets are transmitted, the UE may reduce bandwidth associated with the transmission by aggregating the ACKs and dropping a portion of the ACK packets. For example, to save the bandwidth in uplink for 10 TCP ACKs, the UE may transmit one TCP ACK that includes the aggregated ECN information indicating a packet count for which the ACK corresponds, while dripping the remaining nine TCP ACK packets.

Thus, in certain aspects, if a TCP ACK packet is carrying the aggregated ECN information, the UE may indicate to the modem not to drop any TCP ACK packets in order to prevent the modem from dropping the TCP ACK packet carrying the aggregated ECN information.

In certain aspects, when TCP ACK shaping is active, the UE may override a shaping policy to ensure transmission of uplink packets with ECN bits set to report a congestion on the downlink. For example, a modem may use a TCP ACK shaping algorithm to adjust a number of ACKS or a number of bytes acknowledged on an uplink flow in order to perform traffic shaping. In some examples, the UE may override the shaping policy to ensure that uplink packets with set ECN bits are not being transmitted too early or too late. In other words, the UE may override a shaping policy if it would prevent timely transmission of uplink packets with set ECN bits. Overriding the shaping policy may also be configured to ensure that the aggregated ECN information is timely transmitted to a receiver.

In certain aspects, the UE may be configured to prevent L4S packets with ECN info from being combined (e.g., coalesced) in uplink transmissions when they are moved between entities. For example, an IP packet size or potential size may range from go anywhere from 1 to 264 kilobytes, because of a payload field length of 16 bits. The UE modem may notify the application server and/or application client that it wants IP packets of a particular size (e.g., 1500 bytes packet). Thus, in some examples, relatively small IP packets may be combined into a single package in order to provide efficient communications. In some implementations, the UE may also combine relatively small IP packets into a single larger package to reduce processing power.

However, such combinations may cause communication issues. For example, if 10 packets each have a header with set ECN bits indicating congestion, and if those 10 packets are combined into a larger package with a single header (and thus only one ECN), then the receiver may interpret the larger package as containing only one packet with ECN bits set. Thus, in some examples, the UE may prevent IP packets with set ECN bits from being combined into a larger package so that the receiver understands the correct number of packets having ECN bits set.

In another example, if the UE combines the IP packets with ECN bits into a larger package, the UE may set a congestion bit indicating a probability that reflects a ratio of packets in the combined package having the congestion marked. Thus, here, if 5 packets are coalesced into a larger package, and 2 of the packets had ECN bits set indicating congestion, the UE may mark with uniform probability 2/5.

In certain aspects, a PDU Set configuration (e.g., XR) may be configure packets and communication of packets based on PDU Set Metrics (e.g., PSDB, PSER, PSI, PSIHI). For example, an I-frame packet may be configured with higher priority than a P-frame packet, based on the PDU set metrics. Thus, a P-frame packet may be dropped in response to a congestion notification from a network entity.

In multi-modal association between flows (e.g., Video, Audio, Haptic, etc.), which provides combined immersive experience to application user, when one flow experiences congestion, the UE may set ECN bits of the other associated flows. For example, if a video flow experiences congestion, it may cause collateral congestion with the other flows associated with audio and haptics. However, because the audio and haptics flows are not congested, the UE may set ECN bits of those flows in order to indicate congestion of the video flow in a timely manner.

In some examples, the UE may receive an indication of congestion, or independently determine congestion is occurring at a network entity (e.g., a CU and/or DU). In such a case, the UE may override PDU set metrics to prevent uplink packets from being dropped based on said uplink packets having ECN bits set. For example, such packets may be treated as being associated with a high PDU set importance (PSI).

In some examples, to reduce “ECN bleaching” (e.g., a situation where UE is attempting to indicate congestion in uplink traffic, but no apparent feedback is carried on the DL of the same flow), the UE may directly provide the feedback in the DL packets, in the ECN feedback field. That is, the UE modem or hardware interface may set the ECN bits in the downlink packets prior to the packets reaching the application client on the UE.

### Examples of Network Entity-Side (RAN Level) Aspects

A network entity may communicate (e.g., transmit to, and receive from) data to a UE in downlink and uplink directions. As such, the network entity may also include data plane aspects and radio layers that may contribute to latency in such communications. For example, data may be retransmitted between the UE and network via the MAC layer causing delay, the RLC layer at the network entity may perform management and recovery of lost packets through a status mechanism, and the PDCP layer at a CU may be required to perform data aggregation and reordering management between one or more DUs based on whether dual/single connectivity is used.

In certain aspects, a network entity (e.g., the CU and/or DU) may mark (e.g., set ECN bits) received packets if the network entity identifies packet loss-recovery over a communication link (e.g., NR-U GTP-U based link, as seen in commercial deployments). Such packet loss may be identified via feedback-based retransmissions and/or flow control support. In some examples, even if there are no outstanding packets, additional delay for the current packet which is expected PDCP SN can result in increased latency.

For example, the network entity may modify a PDCP packet in order to set bits of the packet ECN (e.g., the ECN field is part of the IP header). However, if the entity modifies the PDCP packet, it may also have to calculate an IP checksum and after that the PDCP may have to re-perform ciphering and integrity protection. Thus, to avoid such a process, the PDCP layer may associate meta-data with the PDCP packet so that when the IP packet is extracted from the PDCP packet at the IP layer, the IP layer may set the ECN bits of the extracted IP packet based on the associated meta-data for that packet.

In certain aspects, it may not be possible to mark an ECN bit indicating traffic congestion after the PDCP PDU is processed (e.g., ciphered, MAC-I computed). Despite this limitation, congestion at in the radio or data domain should be signaled to the end point. Thus, in some examples, congestion information can be transported over the wireless system via a PDCP (or other radio protocol) bit in the data header, or a control PDU. Thus, the PDCP receiver of the PDCP PDU may check the ECN congestion in the PDCP meta-data.

In certain aspects, the network entity may refrain from perform any combining of MTU based IP packets (typical 1500B) if such combining could result in losing ECN information of the packets, as discussed above in connection with UE procedures. In some examples, the network entity may refrain from combining of MTU based IP packets for a duration of time (e.g., temporarily or at all times). The duration of time may be any suitable length of time, and the duration of time may be (pre-) configured at the network entity. In some examples, the network entity may refrain from dropping TCP ACKs (e.g., toward UPF) using ACK coalescing in order to prevent losing ECN feedback information associated with that flow.

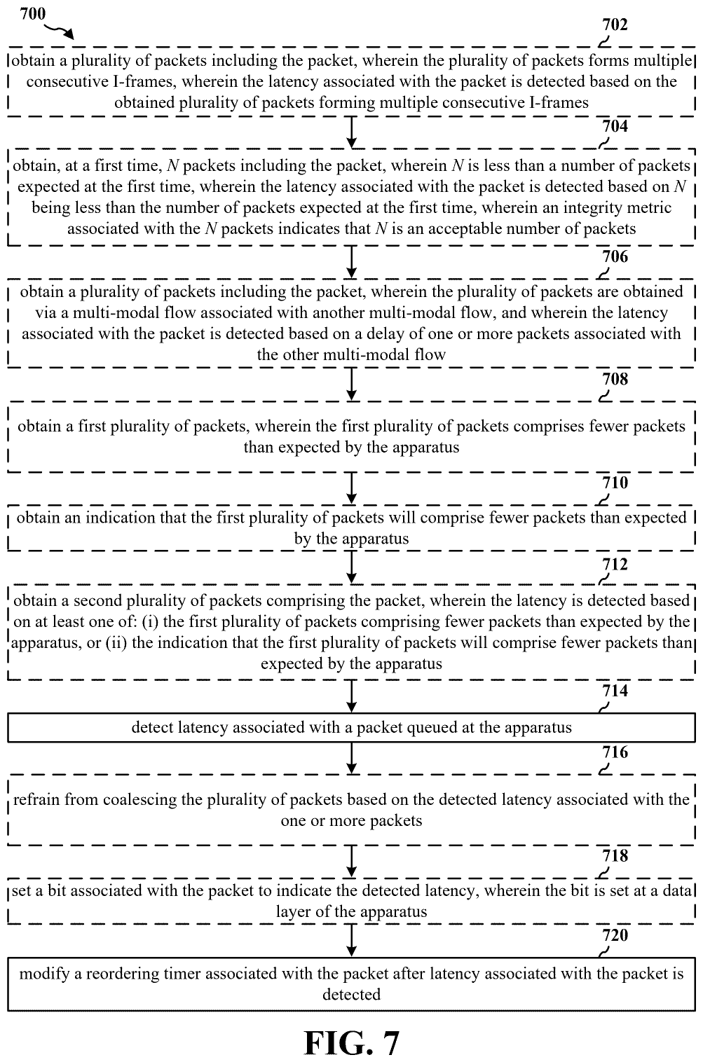

FIG. 7 is a flowchart 700 of a method of wireless communication. The method may be performed by a UE (e.g., the UE 104; the apparatus 1102). Specifically, the method may be performed by one or more memories, processors, and RF front ends (e.g., the memory 360, controller/processor 359, transmitter 354TX, receiver 354RX, antenna 352, etc. of FIG. 3).

The method may also be performed by a network entity or base station (e.g., the base station 102/180; the apparatus 1202. Specifically, the method may be performed by one or more memories, processors, and RF front ends (e.g., the memory 376, controller/processor 375, transmitter 318TX, receiver 318RX, antenna 320, etc. of FIG. 3).

At 702, the UE and/or network entity may optionally obtain a plurality of packets including the packet, wherein the plurality of packets forms multiple consecutive I-frames, wherein the latency associated with the packet is detected based on the obtained plurality of packets forming multiple consecutive I-frames. For example, 702 may be performed by an obtaining component 1140/1240.

At 704, the UE and/or network entity may optionally obtain, at a first time, N packets including the packet, wherein Nis less than a number of packets expected at the first time, wherein the latency associated with the packet is detected based on N being less than the number of packets expected at the first time, wherein an integrity metric associated with the N packets indicates that Nis an acceptable number of packets. For example, 704 may be performed by the obtaining component 1140/1240.

At 706, the UE and/or network entity may optionally obtain a plurality of packets including the packet, wherein the plurality of packets are obtained via a multi-modal flow associated with another multi-modal flow, and wherein the latency associated with the packet is detected based on a delay of one or more packets associated with the other multi-modal flow. For example, 706 may be performed by the obtaining component 1140/1240.

At 708, the UE and/or network entity may optionally obtain a first plurality of packets, wherein the first plurality of packets comprises fewer packets than expected by the apparatus. For example, 708 may be performed by the obtaining component 1140/1240.

At 710, the UE and/or network entity may optionally obtain an indication that the first plurality of packets will comprise fewer packets than expected by the apparatus. For example, 710 may be performed by the obtaining component 1140/1240.

At 712, the UE and/or network entity may optionally obtain a second plurality of packets comprising the packet, wherein the latency is detected based on at least one of: (i) the first plurality of packets comprising fewer packets than expected by the apparatus, or (ii) the indication that the first plurality of packets will comprise fewer packets than expected by the apparatus. For example, 712 may be performed by the obtaining component 1140/1240.

At 714, the UE and/or network entity may detect latency associated with a packet queued at the apparatus. For example, 714 may be performed by a detecting component 1142/1242.

At 716, the UE and/or network entity may optionally refrain, for a duration of time, from coalescing the plurality of packets based on the detected latency associated with the one or more packets. For example, 716 may be performed by a refraining component 1144/1244. It should be noted, the network entity and/or UE may refrain from coalescing the plurality of packets for a duration of time (e.g., duration of the latency, duration of the latency plus x milliseconds, etc.). The duration of time may be any suitable length of time, and the duration of time may be (pre-) configured at the network entity.

At 718, the UE and/or network entity may optionally set a bit associated with the packet to indicate the detected latency, wherein the bit is set at a data layer of the apparatus. For example, 718 may be performed by a setting component 1146/1246.

At 720, the UE and/or network entity may modify a reordering timer associated with the packet after latency associated with the packet is detected. For example, 720 may be performed by a modifying component 1148/1248.

In certain aspects, the latency associated with the packet is detected based on a duration of time that the packet is queued satisfying a threshold condition.

In certain aspects, packet comprises a bit associated with an explicit congestion notification (ECN) field of the packet, and wherein the latency associated with the packet is detected based on the bit.

In certain aspects, the reordering timer comprises a packet data convergence protocol (PDCP) reordering timer.

In certain aspects, the reordering timer is modified at a bearer level, an application flow level, or a quality of service (QOS) flow level.

In certain aspects, the reordering timer is modified based on the detected latency associated with the packet and a type of traffic associated with the packet.

In certain aspects, the type of traffic comprises low latency, low loss, and scalable throughput (L4S) type traffic and non-L4S type traffic, and wherein the reordering timer is modified based on the type of traffic associated with the packet being L4S type traffic.

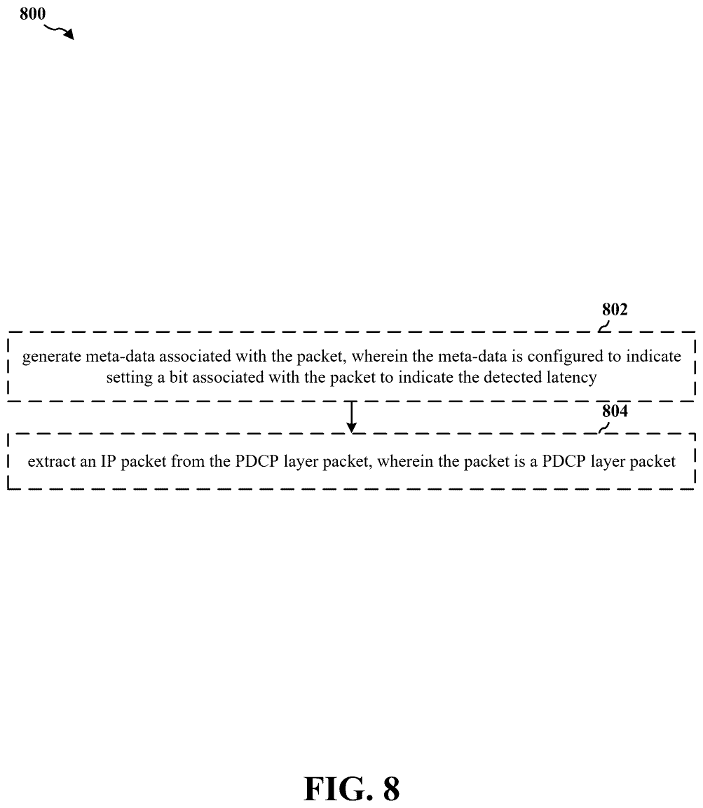

FIG. 8 is a flowchart 800 of a method of wireless communication. The method may be performed by a UE (e.g., the UE 104; the apparatus 1102). Specifically, the method may be performed by one or more memories, processors, and RF front ends (e.g., the memory 360, controller/processor 359, transmitter 354TX, receiver 354RX, antenna 352, etc. of FIG. 3).

The method may also be performed by a network entity or base station (e.g., the base station 102/180; the apparatus 1202. Specifically, the method may be performed by one or more memories, processors, and RF front ends (e.g., the memory 376, controller/processor 375, transmitter 318TX, receiver 318RX, antenna 320, etc. of FIG. 3).

One or more aspects of the method illustrated in FIG. 8 may be performed in combination with one or more aspects of the other flow charts illustrated in FIGS. 7, 9, and 10.

At 802, the UE and/or network entity may optionally generate meta-data associated with the packet, wherein the meta-data is configured to indicate setting a bit associated with the packet to indicate the detected latency. For example, 802 may be performed by a generating component 1150/1250.

At 804, the UE and/or network entity may optionally extract an IP packet from the PDCP layer packet, wherein the packet is a PDCP layer packet. For example, 804 may be performed by an extracting component 1152/1252.

In certain aspects, the indication of the latency comprises an explicit congestion notification (ECN) field of at least one of the plurality of packets.

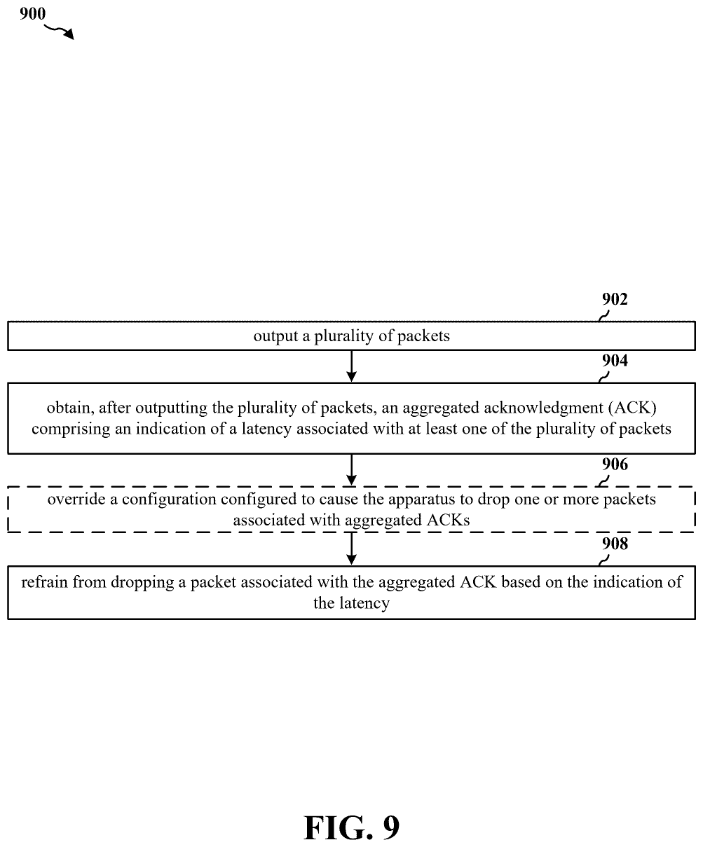

FIG. 9 is a flowchart 900 of a method of wireless communication. The method may be performed by a UE (e.g., the UE 104; the apparatus 1102). Specifically, the method may be performed by one or more memories, processors, and RF front ends (e.g., the memory 360, controller/processor 359, transmitter 354TX, receiver 354RX, antenna 352, etc. of FIG. 3).

The method may also be performed by a network entity or base station (e.g., the base station 102/180; the apparatus 1202. Specifically, the method may be performed by one or more memories, processors, and RF front ends (e.g., the memory 376, controller/processor 375, transmitter 318TX, receiver 318RX, antenna 320, etc. of FIG. 3).

One or more aspects of the method illustrated in FIG. 9 may be performed in combination with one or more aspects of the other flow charts illustrated in FIGS. 7, 8, and 10.

At 902, the UE and/or network entity may output a plurality of packets. For example, 802 may be performed by an outputting component 1154/1254.

At 904, the UE and/or network entity may obtain, after outputting the plurality of packets, an aggregated acknowledgment (ACK) comprising an indication of a latency associated with at least one of the plurality of packets. For example, 904 may be performed by the obtaining component 1140/1240.

At 906, the UE and/or network entity may optionally override a configuration configured to cause the apparatus to drop one or more packets associated with aggregated ACKs. For example, 906 may be performed by an overriding component 1156/1256.

At 908, the UE and/or network entity may refrain, for a duration of time, from dropping a packet associated with the aggregated ACK based on the indication of the latency. For example, 908 may be performed by the refraining component 1144/1244. It should be noted, the network entity and/or UE may refrain from dropping a packet associated with the aggregated ACK for a duration of time (e.g., duration of the latency, duration of the latency plus x milliseconds, etc.). The duration of time may be any suitable length of time, and the duration of time may be (pre-) configured at the network entity.

In certain aspects, the indication of the latency comprises an explicit congestion notification (ECN) field of at least one of the plurality of packets.

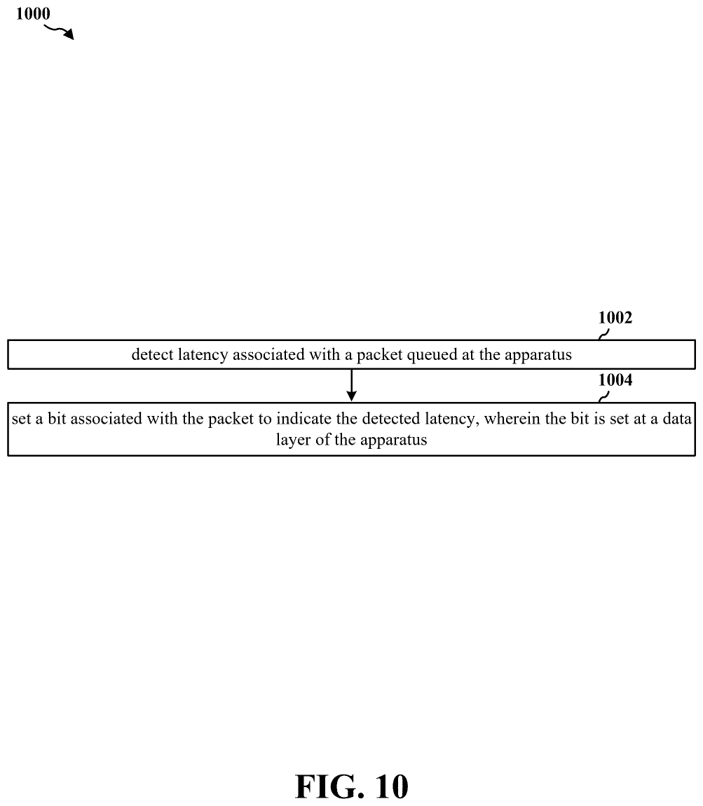

FIG. 10 is a flowchart 1000 of a method of wireless communication. The method may be performed by a UE (e.g., the UE 104; the apparatus 1102). Specifically, the method may be performed by one or more memories, processors, and RF front ends (e.g., the memory 360, controller/processor 359, transmitter 354TX, receiver 354RX, antenna 352, etc. of FIG. 3).

The method may also be performed by a network entity or base station (e.g., the base station 102/180; the apparatus 1202. Specifically, the method may be performed by one or more memories, processors, and RF front ends (e.g., the memory 376, controller/processor 375, transmitter 318TX, receiver 318RX, antenna 320, etc. of FIG. 3).

One or more aspects of the method illustrated in FIG. 10 may be performed in combination with one or more aspects of the other flow charts illustrated in FIGS. 7, 8, and 9.

At 1002, the UE and/or network entity may detect latency associated with a packet queued at the apparatus. For example, 1002 may be performed by the detecting component 1142/1242.

At 1004, the UE and/or network entity may set a bit associated with the packet to indicate the detected latency, wherein the bit is set at a data layer of the apparatus. For example, 1004 may be performed by the detecting component 1146/1246.

In certain aspects, the bit is set at one or more of: an application processor, an interconnect between the application processor and a modem, or the modem.

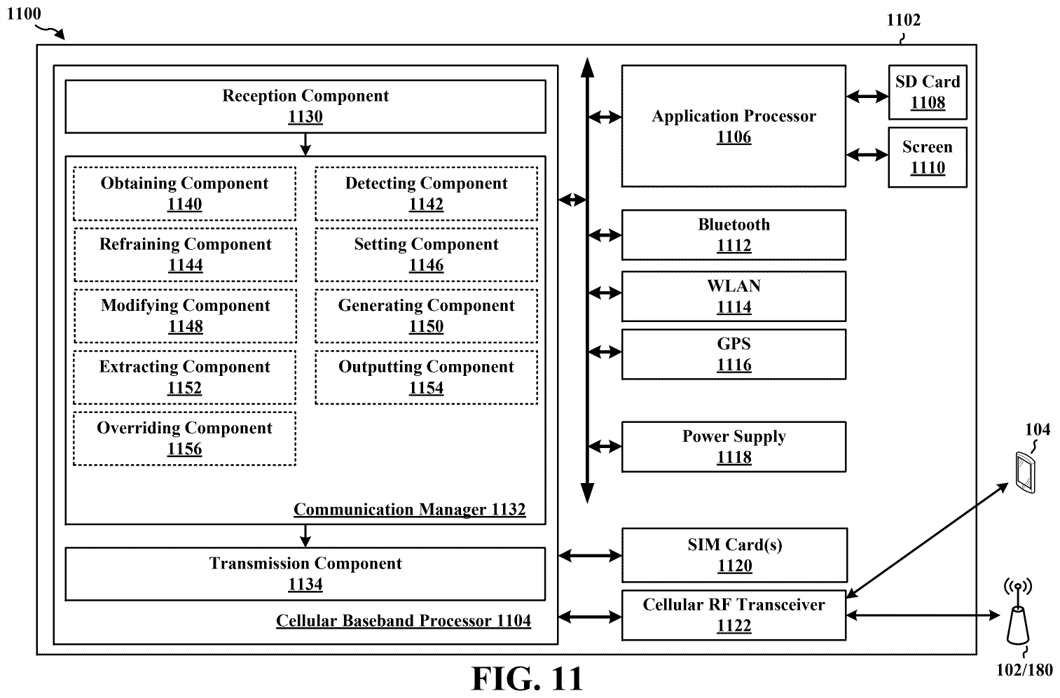

FIG. 11 is a diagram 1100 illustrating an example of a hardware implementation for an apparatus 1102. The apparatus 1102 is a UE and includes a cellular baseband processor 1104 (also referred to as a modem) coupled to one or more cellular RF transceivers 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the one or more cellular RF transceivers 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 104 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see UE 104 of FIG. 3) and include the aforediscussed additional modules of the apparatus 1102. In various examples, the apparatus 1102 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1132 includes an obtaining component 1140 configured to: obtain a plurality of packets including the packet, wherein the plurality of packets forms multiple consecutive I-frames, wherein the latency associated with the packet is detected based on the obtained plurality of packets forming multiple consecutive I-frames; obtain, at a first time, N packets including the packet, wherein N is less than a number of packets expected at the first time, wherein the latency associated with the packet is detected based on N being less than the number of packets expected at the first time, wherein an integrity metric associated with the N packets indicates that N is an acceptable number of packets; obtain a plurality of packets including the packet, wherein the plurality of packets are obtained via a multi-modal flow associated with another multi-modal flow, and wherein the latency associated with the packet is detected based on a delay of one or more packets associated with the other multi-modal flow; obtain a first plurality of packets, wherein the first plurality of packets comprises fewer packets than expected by the apparatus; obtain an indication that the first plurality of packets will comprise fewer packets than expected by the apparatus; obtain a second plurality of packets comprising the packet, wherein the latency is detected based on at least one of: (i) the first plurality of packets comprising fewer packets than expected by the apparatus, or (ii) the indication that the first plurality of packets will comprise fewer packets than expected by the apparatus; and obtain, after outputting the plurality of packets, an aggregated acknowledgment (ACK) comprising an indication of a latency associated with at least one of the plurality of packets. E.g., as described in connection with 702-712 and 904.

The communication manager 1132 further includes a detecting component 1142 configured to: detect latency associated with a packet queued at the apparatus;, e.g., as described in connection with 714 and 1002.

The communication manager 1132 further includes a refraining component 1144 configured to: refrain, for a duration of time, from coalescing the plurality of packets based on the detected latency associated with the one or more packets; and refrain, for a duration of time, from dropping a packet associated with the aggregated ACK based on the indication of the latency; e.g., as described in connection with 716 and 908. It should be noted, the network entity and/or UE may refrain from coalescing the plurality of packets for a duration of time (e.g., duration of the latency, duration of the latency plus x milliseconds, etc.). The duration of time may be any suitable length of time, and the duration of time may be (pre-) configured at the network entity.

The communication manager 1132 further includes a setting component 1146 configured to: set a bit associated with the packet to indicate the detected latency, wherein the bit is set at a data layer of the apparatus, e.g., as described in connection with 718 and 1004.

The communication manager 1132 further includes a modifying component 1148 configured to: modify a reordering timer associated with the packet after latency associated with the packet is detected; e.g., as described in connection with 720.

The communication manager 1132 further includes a generating component 1150 configured to: generate meta-data associated with the packet, wherein the meta-data is configured to indicate setting a bit associated with the packet to indicate the detected latency, e.g., as described in connection with 802.

The communication manager 1132 further includes an extracting component 1152 configured to: extract an IP packet from the PDCP layer packet, wherein the packet is a PDCP layer packet, e.g., as described in connection with 804.

The communication manager 1132 further includes an outputting component 1154 configured to: output a plurality of packets, e.g., as described in connection with 902.

The communication manager 1132 further includes an overriding component 1156 configured to override a configuration configured to cause the apparatus to drop one or more packets associated with aggregated ACKs, e.g., as described in connection with 906.

The apparatus may include additional components that perform each of the blocks of the algorithm in the aforementioned flowcharts of FIG. 7-10. As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes: means for obtaining a plurality of packets including the packet, wherein the plurality of packets forms multiple consecutive I-frames, wherein the latency associated with the packet is detected based on the obtained plurality of packets forming multiple consecutive I-frames; means for obtaining, at a first time, N packets including the packet, wherein N is less than a number of packets expected at the first time, wherein the latency associated with the packet is detected based on N being less than the number of packets expected at the first time, wherein an integrity metric associated with the N packets indicates that N is an acceptable number of packets; means for obtaining a plurality of packets including the packet, wherein the plurality of packets are obtained via a multi-modal flow associated with another multi-modal flow, and wherein the latency associated with the packet is detected based on a delay of one or more packets associated with the other multi-modal flow; means for obtaining a first plurality of packets, wherein the first plurality of packets comprises fewer packets than expected by the apparatus; means for obtaining an indication that the first plurality of packets will comprise fewer packets than expected by the apparatus; means for obtaining a second plurality of packets comprising the packet, wherein the latency is detected based on at least one of: (i) the first plurality of packets comprising fewer packets than expected by the apparatus, or (ii) the indication that the first plurality of packets will comprise fewer packets than expected by the apparatus; means for detecting latency associated with a packet queued at the apparatus; means for refraining from coalescing the plurality of packets based on the detected latency associated with the one or more packets; means for setting a bit associated with the packet to indicate the detected latency, wherein the bit is set at a data layer of the apparatus; means for modifying a reordering timer associated with the packet after latency associated with the packet is detected; means for generating meta-data associated with the packet, wherein the meta-data is configured to indicate setting a bit associated with the packet to indicate the detected latency; means for extracting an IP packet from the PDCP layer packet, wherein the packet is a PDCP layer packet; means for outputting a plurality of packets; means for obtaining, after outputting the plurality of packets, an aggregated acknowledgment (ACK) comprising an indication of a latency associated with at least one of the plurality of packets; means for overriding a configuration configured to cause the apparatus to drop one or more packets associated with aggregated ACKs; means for refraining from dropping a packet associated with the aggregated ACK based on the indication of the latency; means for detecting latency associated with a packet queued at the apparatus; means for setting a bit associated with the packet to indicate the detected latency, wherein the bit is set at a data layer of the apparatus.

The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for detecting, means for refraining, means for modifying, means for generating, means for extracting, means for overriding, and means for setting may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

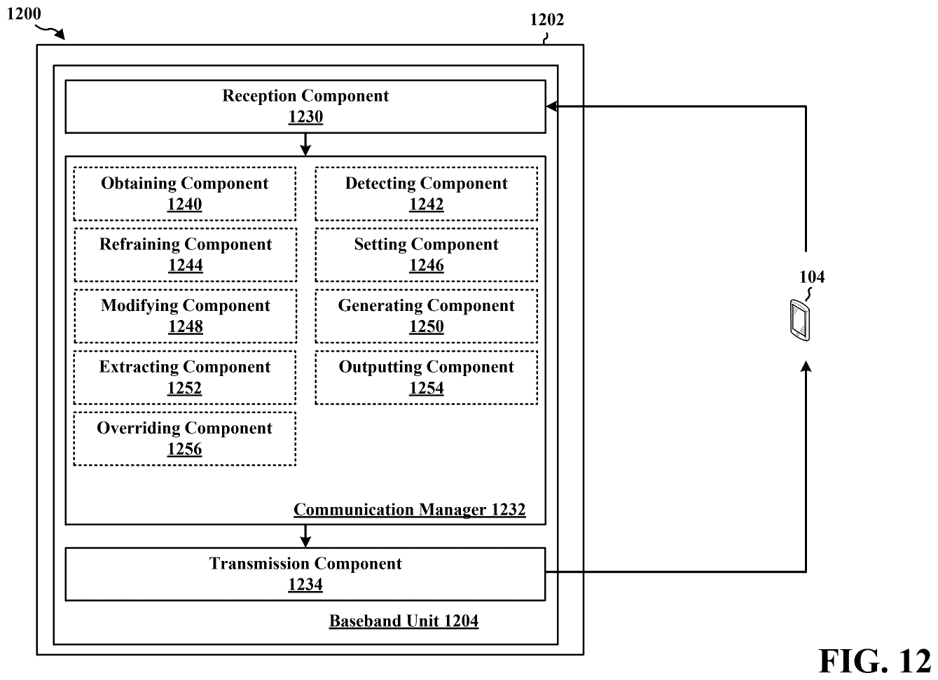

FIG. 12 is a diagram 1200 illustrating an example of a hardware implementation for an apparatus 1202. The apparatus 1202 is a BS and includes a baseband unit 1204. The baseband unit 1204 may communicate through one or more cellular RF transceivers with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the BS 102/180 and may include the memory 376 and/or at least one of the TX processor 316, the RX processor 370, and the controller/processor 375. In various examples, the apparatus 1202 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1232 includes an obtaining component 1240 configured to: obtain a plurality of packets including the packet, wherein the plurality of packets forms multiple consecutive I-frames, wherein the latency associated with the packet is detected based on the obtained plurality of packets forming multiple consecutive I-frames; obtain, at a first time, N packets including the packet, wherein N is less than a number of packets expected at the first time, wherein the latency associated with the packet is detected based on N being less than the number of packets expected at the first time, wherein an integrity metric associated with the N packets indicates that N is an acceptable number of packets; obtain a plurality of packets including the packet, wherein the plurality of packets are obtained via a multi-modal flow associated with another multi-modal flow, and wherein the latency associated with the packet is detected based on a delay of one or more packets associated with the other multi-modal flow; obtain a first plurality of packets, wherein the first plurality of packets comprises fewer packets than expected by the apparatus; obtain an indication that the first plurality of packets will comprise fewer packets than expected by the apparatus; obtain a second plurality of packets comprising the packet, wherein the latency is detected based on at least one of: (i) the first plurality of packets comprising fewer packets than expected by the apparatus, or (ii) the indication that the first plurality of packets will comprise fewer packets than expected by the apparatus; and obtain, after outputting the plurality of packets, an aggregated acknowledgment (ACK) comprising an indication of a latency associated with at least one of the plurality of packets. E.g., as described in connection with 702-712 and 904.

The communication manager 1232 further includes a detecting component 1242 configured to: detect latency associated with a packet queued at the apparatus; e.g., as described in connection with 714 and 1002.

The communication manager 1232 further includes a refraining component 1244 configured to: refrain, for a duration of time, from coalescing the plurality of packets based on the detected latency associated with the one or more packets; and refrain, for a duration of time, from dropping a packet associated with the aggregated ACK based on the indication of the latency; e.g., as described in connection with 716 and 908.

The communication manager 1232 further includes a setting component 1246 configured to: set a bit associated with the packet to indicate the detected latency, wherein the bit is set at a data layer of the apparatus, e.g., as described in connection with 718 and 1004.

The communication manager 1232 further includes a modifying component 1248 configured to: modify a reordering timer associated with the packet after latency associated with the packet is detected; e.g., as described in connection with 720.

The communication manager 1232 further includes a generating component 1250 configured to: generate meta-data associated with the packet, wherein the meta-data is configured to indicate setting a bit associated with the packet to indicate the detected latency, e.g., as described in connection with 802.

The communication manager 1232 further includes an extracting component 1252 configured to: extract an IP packet from the PDCP layer packet, wherein the packet is a PDCP layer packet, e.g., as described in connection with 804.

The communication manager 1232 further includes an outputting component 1254 configured to: output a plurality of packets, e.g., as described in connection with 902.

The communication manager 1232 further includes an overriding component 1256 configured to override a configuration configured to cause the apparatus to drop one or more packets associated with aggregated ACKs, e.g., as described in connection with 906. The apparatus may include additional components that perform each of the blocks of the algorithm in the aforementioned flowcharts of FIGS. 7-10.

As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes: means for obtaining a plurality of packets including the packet, wherein the plurality of packets forms multiple consecutive I-frames, wherein the latency associated with the packet is detected based on the obtained plurality of packets forming multiple consecutive I-frames; means for obtaining, at a first time, N packets including the packet, wherein Nis less than a number of packets expected at the first time, wherein the latency associated with the packet is detected based on N being less than the number of packets expected at the first time, wherein an integrity metric associated with the N packets indicates that N is an acceptable number of packets; means for obtaining a plurality of packets including the packet, wherein the plurality of packets are obtained via a multi-modal flow associated with another multi-modal flow, and wherein the latency associated with the packet is detected based on a delay of one or more packets associated with the other multi-modal flow; means for obtaining a first plurality of packets, wherein the first plurality of packets comprises fewer packets than expected by the apparatus; means for obtaining an indication that the first plurality of packets will comprise fewer packets than expected by the apparatus; means for obtaining a second plurality of packets comprising the packet, wherein the latency is detected based on at least one of: (i) the first plurality of packets comprising fewer packets than expected by the apparatus, or (ii) the indication that the first plurality of packets will comprise fewer packets than expected by the apparatus; means for detecting latency associated with a packet queued at the apparatus; means for refraining from coalescing the plurality of packets based on the detected latency associated with the one or more packets; means for setting a bit associated with the packet to indicate the detected latency, wherein the bit is set at a data layer of the apparatus; means for modifying a reordering timer associated with the packet after latency associated with the packet is detected; means for generating meta-data associated with the packet, wherein the meta-data is configured to indicate setting a bit associated with the packet to indicate the detected latency; means for extracting an IP packet from the PDCP layer packet, wherein the packet is a PDCP layer packet; means for outputting a plurality of packets; means for obtaining, after outputting the plurality of packets, an aggregated acknowledgment (ACK) comprising an indication of a latency associated with at least one of the plurality of packets; means for overriding a configuration configured to cause the apparatus to drop one or more packets associated with aggregated ACKs; means for refraining from dropping a packet associated with the aggregated ACK based on the indication of the latency; means for detecting latency associated with a packet queued at the apparatus; means for setting a bit associated with the packet to indicate the detected latency, wherein the bit is set at a data layer of the apparatus.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for detecting, means for refraining, means for modifying, means for generating, means for extracting, means for overriding, and means for setting may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### EXAMPLE ASPECTS

The following examples are illustrative only and may be combined with aspects of other embodiments or teachings described herein, without limitation.

Example 1 is a method at a wireless node, comprising: detecting latency associated with a packet queued at the wireless node; and setting a bit associated with the packet to indicate the detected latency, wherein the bit is set at a data layer of the wireless node.

Example 2 is the method of Example 1, wherein the bit is associated with an explicit congestion notification (ECN) field of the packet.

Example 3 is the method of any of Examples 1 and 2, wherein the bit is set at one or more of: an application processor, an interconnect between the application processor and a modem, or the modem.

Example 4 is the method of any of Examples 1-3, further comprising: monitoring at least one radio bearer used by the wireless node, wherein the detected latency is further associated with the at least one radio bearer, and wherein the packet was obtained or is to be output for transmission via the at least one radio bearer or another radio bearer associated with the at least one radio bearer.

Example 5 is the method of Example 4, wherein the latency associated with the packet is detected based on a function of: (1) a guaranteed bit rate (GBR) or a prioritized bit rate (PBR) associated with the at least one radio bearer, and (ii) an actual data throughput of the at least one radio bearer, satisfying a threshold condition.

Example 6 is the method of any of Examples 4 and 5, wherein the latency associated with the packet is detected based on a queueing time for packets at the at least one radio bearer satisfying a threshold condition.

Example 7 is the method of any of Examples 1-6, further comprising: overriding, with regard to outputting the packet for transmission, an aggregated ACK feedback mechanism, wherein the override is based on the set bit associated with the packet.

Example 8 is the method of any of Examples 1-7, further comprising: overriding, with regard to outputting the packet for transmission, a packet shaping mechanism, wherein the override is based on the set bit associated with the packet.

Example 9 is the method of any of Examples 1-8, wherein the method further comprises: overriding, with regard to outputting the packet for transmission, a packet aggregation mechanism, wherein the override is based on the set bit associated with the packet.

Example 10 is the method of any of Examples 1-9, further comprising: combining, via a packet aggregation mechanism, the packet with another packet to form an aggregated package; and setting a bit associated with the aggregated package to indicate a ratio of packets within the package having the bit set.

Example 11 is the method of any of Examples 1-10, wherein the packet corresponds to a first traffic flow of a plurality of traffic flows associated with a multi-modal extended reality (XR), wherein the detected latency associated with the packet is a latency of a second traffic flow of the plurality of flows, and wherein the bit is set based on at least one of: (i) the detected latency of the second flow, or (ii) the first traffic flow and the second traffic flow being associated with the multi-modal XR.

Example 12 is the method of any of Examples 1-11, further comprising: overriding a protocol data unit (PDU) metric configured to drop the packet prior to outputting the packet for transmission.

Example 13 is the method of Example 12, wherein the PDU metric comprises at least one of: packet set delay budget (PSDB), a PDU set error rate (PSER), a PDU set importance (PSI), or a PDU set integrated handling information (PSIHI).

Example 14 is the method of any of Examples 1-13, wherein the packet is a downlink packet, and wherein the latency is detected based on a ratio of: (i) a rate of receiving downlink packets at the wireless node, and (ii) a rate of transmitting uplink packets from the wireless node, and wherein the bit is set based on the rate of receiving downlink packets being less than the rate of receiving uplink packets.

Example 15 is the method of any of Examples 1-14, wherein the latency associated with the packet is detected based on a packet loss detected over a link between the wireless node and a distribution unit (DU), wherein the packet is associated with the link.

Example 16 is the method of Example 15, wherein the link is a new radio unlicensed (NR-U) link.

Example 17 is the method of any of Examples 1-16, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 18 is the method of any of Examples 1-17, further comprising: obtaining, at a first time, N packets including the packet, wherein Nis less than a number of packets expected at the first time, wherein the latency associated with the packet is detected based on N being less than the number of packets expected at the first time.

Example 19 is the method of Example 18, wherein an integrity metric associated with the N packets indicates that Nis an acceptable number of packets.

Example 20 is the method of any of Examples 1-19, further comprising: obtaining a plurality of packets including the packet, wherein the plurality of packets are obtained via a multi-modal flow associated with another multi-modal flow, and wherein the latency associated with the packet is detected based on a delay of one or more packets associated with the other multi-modal flow.

Example 21 is the method of any of Examples 1-20, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 22 is the method of any of Examples 1-21, further comprising: obtaining a first plurality of packets, wherein the first plurality of packets comprises fewer packets than expected by the wireless node; obtaining an indication that the first plurality of packets will comprise fewer packets than expected by the wireless node; and obtaining a second plurality of packets comprising the packet, wherein the latency is detected based on at least one of: (i) the first plurality of packets comprising fewer packets than expected by the wireless node, or (ii) the indication that the first plurality of packets will comprise fewer packets than expected by the wireless node.

Example 23 is the method of any of Examples 1-22, wherein the latency associated with the packet is detected based on a duration of time that the packet is queued satisfying a threshold condition.

Example 24 is a method at a wireless node, comprising: detecting latency associated with a packet queued at the wireless node; and modifying a reordering timer associated with the packet after latency associated with the packet is detected.

Example 25 is the method of Example 24, wherein the packet comprises a bit associated with an explicit congestion notification (ECN) field of the packet, and wherein the latency associated with the packet is detected based on the bit.

Example 26 is the method any of Examples 24 and 25, wherein the reordering timer comprises a packet data convergence protocol (PDCP) reordering timer.

Example 27 is the method of any of Examples 24-26, wherein the reordering timer is modified at a bearer level, an application flow level, or a quality of service (QOS) flow level.

Example 28 is the method of any of Examples 24-27, wherein the reordering timer is modified based on the detected latency associated with the packet and a type of traffic associated with the packet.

Example 29 is the method of Example 28, wherein the type of traffic comprises low latency, low loss, and scalable throughput (L4S) type traffic and non-L4S type traffic, and wherein the reordering timer is modified based on the type of traffic associated with the packet being L4S type traffic.

Example 30 is the method of any of Examples 24-29, wherein the packet comprises a bit associated with an explicit congestion notification (ECN) field of the packet, and wherein the bit is set at one or more of: an application processor, an interconnect between the application processor and a modem, or the modem.

Example 31 is the method of Example 30, further comprising: overriding, with regard to outputting the packet for transmission, an aggregated ACK feedback mechanism, wherein the override is based on the set bit associated with the packet.

Example 32 is the method of any of Examples 30 and 31, further comprising: overriding, with regard to outputting the packet for transmission, a packet shaping mechanism, wherein the override is based on the set bit associated with the packet.

Example 33 is the method of any of Examples 30-32, further comprising: overriding, with regard to outputting the packet for transmission, a packet aggregation mechanism, wherein the override is based on the set bit associated with the packet.

Example 34 is the method of any of Examples 24-33, further comprising: monitoring at least one radio bearer used by the wireless node, wherein the detected latency is further associated with the at least one radio bearer, and wherein the packet was obtained or is to be output for transmission via the at least one radio bearer or another radio bearer associated with the at least one radio bearer.

Example 35 is the method of Example 34, wherein the latency associated with the packet is detected based on a function of: (1) a guaranteed bit rate (GBR) or a prioritized bit rate (PBR) associated with the at least one radio bearer, and (ii) an actual data throughput of the at least one radio bearer, satisfying a threshold condition.

Example 36 is the method of any of Examples 34 and 35, wherein the latency associated with the packet is detected based on a queueing time for packets at the at least one radio bearer satisfying a threshold condition.

Example 37 is the method of any of Examples 24-36, further comprising: combining, via a packet aggregation mechanism, the packet with another packet to form an aggregated package; and setting a bit associated with the aggregated package to indicate a ratio of packets within the package having the bit set.

Example 38 is the method of Example 37, wherein the packet corresponds to a first traffic flow of a plurality of traffic flows associated with a multi-modal extended reality (XR), wherein the detected latency associated with the packet is a latency of a second traffic flow of the plurality of flows, and wherein the bit is set based on at least one of: (i) the detected latency of the second flow, or (ii) the first traffic flow and the second traffic flow being associated with the multi-modal XR.

Example 39 is the method of any of Examples 37 and 38, wherein the packet is a downlink packet, and wherein the latency is detected based on a ratio of: (i) a rate of receiving downlink packets at the wireless node, and (ii) a rate of transmitting uplink packets from the wireless node, and wherein the bit is set based on the rate of receiving downlink packets being less than the rate of receiving uplink packets.

Example 40 is the method of any of Examples 24-39, further comprising: overriding a protocol data unit (PDU) metric configured to drop the packet prior to outputting the packet for transmission.

Example 41 is the method of Example 40, wherein the PDU metric comprises at least one of: packet set delay budget (PSDB), a PDU set error rate (PSER), a PDU set importance (PSI), or a PDU set integrated handling information (PSIHI).

Example 42 is the method of any of Examples 24-41, wherein the latency associated with the packet is detected based on a packet loss detected over a link between the wireless node and a distribution unit (DU), wherein the packet is associated with the link.

Example 43 is the method of Example 42, wherein the link is a new radio unlicensed (NR-U) link.

Example 44 is the method of any of Examples 24-43, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 45 is the method of any of Examples 24-44, further comprising: obtaining, at a first time, N packets including the packet, wherein N is less than a number of packets expected at the first time, wherein the latency associated with the packet is detected based on N being less than the number of packets expected at the first time.

Example 46 is the method of Example 45, wherein an integrity metric associated with the N packets indicates that N is an acceptable number of packets.

Example 47 is the method of any of Examples 24-46, further comprising: obtaining a plurality of packets including the packet, wherein the plurality of packets are obtained via a multi-modal flow associated with another multi-modal flow, and wherein the latency associated with the packet is detected based on a delay of one or more packets associated with the other multi-modal flow.

Example 48 is the method of any of Examples 24-47, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 49 is the method of any of Examples 24-48, further comprising: obtaining a first plurality of packets, wherein the first plurality of packets comprises fewer packets than expected by the wireless node; obtaining an indication that the first plurality of packets will comprise fewer packets than expected by the wireless node; and obtaining a second plurality of packets comprising the packet, wherein the latency is detected based on at least one of: (i) the first plurality of packets comprising fewer packets than expected by the wireless node, or (ii) the indication that the first plurality of packets will comprise fewer packets than expected by the wireless node.

Example 50 is the method of any of Examples 24-49, wherein the latency associated with the packet is detected based on a duration of time that the packet is queued satisfying a threshold condition.

Example 51 is a method at a wireless node, comprising: outputting a plurality of packets; obtaining, after outputting the plurality of packets, an aggregated acknowledgment (ACK) comprising an indication of a latency associated with at least one of the plurality of packets; and refrain, for a duration of time, from dropping a packet associated with the aggregated ACK based on the indication of the latency.

Example 52 is the method of Example 51, further comprising: overriding a configuration configured to cause the wireless node to drop one or more packets associated with aggregated ACKs, wherein the packet comprises a bit associated with an explicit congestion notification (ECN) field of the packet, and wherein the latency associated with the packet is detected based on the bit.

Example 53 is the method of Example 52, wherein the bit is set at one or more of: an application processor, an interconnect between the application processor and a modem, or the modem.

Example 54 is the method of any of Examples 51-53, wherein the method further comprises modifying a reordering timer associated with the packet after latency associated with the packet is detected, wherein the reordering timer comprises a packet data convergence protocol (PDCP) reordering timer.

Example 55 is the method of any of Examples 51-54, wherein the method further comprises modifying a reordering timer associated with the packet after latency associated with the packet is detected, wherein the reordering timer is modified at a bearer level, an application flow level, or a quality of service (QOS) flow level.

Example 56 is the method of any of Examples 51-55, wherein the method further comprises modifying a reordering timer associated with the packet after latency associated with the packet is detected, wherein the reordering timer is modified based on the detected latency associated with the packet and a type of traffic associated with the packet.

Example 57 is the method of Example 56, wherein the type of traffic comprises low latency, low loss, and scalable throughput (L4S) type traffic and non-L4S type traffic, and wherein the reordering timer is modified based on the type of traffic associated with the packet being L4S type traffic.

Example 58 is the method of any of Examples 51-57, further comprising: monitoring at least one radio bearer used by the wireless node, wherein the latency associated with the packet is further associated with the at least one radio bearer, and wherein the packet was obtained or is to be output for transmission via the at least one radio bearer or another radio bearer associated with the at least one radio bearer.

Example 59 is the method of Example 58, wherein the latency associated with the packet is detected based on a function of: (1) a guaranteed bit rate (GBR) or a prioritized bit rate (PBR) associated with the at least one radio bearer, and (ii) an actual data throughput of the at least one radio bearer, satisfying a threshold condition.

Example 60 is the method of any of Examples 58 and 59, wherein the latency associated with the packet is detected based on a queueing time for packets at the at least one radio bearer satisfying a threshold condition.

Example 61 is the method of any of Examples 51-60, further comprising: combining, via a packet aggregation mechanism, the packet with another packet to form an aggregated package; and setting a bit associated with the aggregated package to indicate a ratio of packets within the package having the bit set.

Example 62 is the method of Example 61, further comprising: overriding, with regard to outputting the packet for transmission, an aggregated ACK feedback mechanism, wherein the override is based on the set bit associated with the packet.

Example 63 is the method of any of Examples 61 and 62, further comprising: overriding, with regard to outputting the packet for transmission, a packet shaping mechanism, wherein the override is based on the set bit associated with the packet.

Example 64 is the method of any of Examples 61-63, further comprising: overriding, with regard to outputting the packet for transmission, a packet aggregation mechanism, wherein the override is based on the set bit associated with the packet.

Example 65 is the method of any of Examples 61-64, wherein the packet corresponds to a first traffic flow of a plurality of traffic flows associated with a multi-modal extended reality (XR), wherein the latency associated with the packet is a latency of a second traffic flow of the plurality of flows, and wherein the bit is set based on at least one of: (i) the detected latency of the second flow, or (ii) the first traffic flow and the second traffic flow being associated with the multi-modal XR.

Example 66 is the method of any of Examples 61-66, wherein the packet is a downlink packet, and wherein the latency is detected based on a ratio of: (i) a rate of receiving downlink packets at the wireless node, and (ii) a rate of transmitting uplink packets from the wireless node, and wherein the bit is set based on the rate of receiving downlink packets being less than the rate of receiving uplink packets.

Example 67 is the method of any of Examples 51-66, further comprising: override a protocol data unit (PDU) metric configured to drop the packet prior to outputting the packet for transmission.

Example 68 is the method of Example 67, wherein the PDU metric comprises at least one of: packet set delay budget (PSDB), a PDU set error rate (PSER), a PDU set importance (PSI), or a PDU set integrated handling information (PSIHI).

Example 69 is the method of any of Examples 51-68, wherein the latency associated with the packet is detected based on a packet loss detected over a link between the wireless node and a distribution unit (DU), wherein the packet is associated with the link.

Example 70 is the method of Example 69, wherein the link is a new radio unlicensed (NR-U) link.

Example 71 is the method of any of Examples 51-70, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 72 is the method of any of Examples 51-71, further comprising: obtaining, at a first time, N packets including the packet, wherein N is less than a number of packets expected at the first time, wherein the latency associated with the packet is detected based on N being less than the number of packets expected at the first time.

Example 73 is the method of Example 72, wherein an integrity metric associated with the N packets indicates that Nis an acceptable number of packets.

Example 74 is the method of any of Examples 51-73, further comprising: obtaining a plurality of packets including the packet, wherein the plurality of packets are obtained via a multi-modal flow associated with another multi-modal flow, and wherein the latency associated with the packet is detected based on a delay of one or more packets associated with the other multi-modal flow.

Example 75 is the method of any of Examples 51-74, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 76 is the method of any of Examples 51-75, further comprising: obtaining a first plurality of packets, wherein the first plurality of packets comprises fewer packets than expected by the wireless node; obtaining an indication that the first plurality of packets will comprise fewer packets than expected by the wireless node; and obtaining a second plurality of packets comprising the packet, wherein the latency is detected based on at least one of: (i) the first plurality of packets comprising fewer packets than expected by the wireless node, or (ii) the indication that the first plurality of packets will comprise fewer packets than expected by the wireless node.

Example 77 is the method of any of Examples 51-76, wherein the latency associated with the packet is detected based on a duration of time that the packet is queued satisfying a threshold condition.

Example 78 is a method at a wireless node, comprising: detecting latency associated with one or more packets of a plurality of packets queued at the wireless node; modifying a reordering timer associated with the packet after latency associated with the packet is detected; and refraining from coalescing the plurality of packets based on the detected latency associated with the one or more packets.

Example 79 is the method of Example 78, wherein each of the one or more packets comprise a bit associated with an explicit congestion notification (ECN) field of the packet, and wherein the latency associated with the one or more packets is detected based on the bit.

Example 80 is the method of Example 79, wherein the bit is associated with an explicit congestion notification (ECN) field of the packet.

Example 81 is the method of any of Examples 79 and 80, wherein the bit is set at one or more of: an application processor, an interconnect between the application processor and a modem, or the modem.

Example 82 is the method of any of Examples 79-81, further comprising: overriding, with regard to outputting the packet for transmission, an aggregated ACK feedback mechanism, wherein the override is based on the bit associated with the packet being set.

Example 83 is the method of any of Examples 79-82, further comprising: overriding, with regard to outputting the packet for transmission, a packet shaping mechanism, wherein the override is based on the bit associated with the packet being set.

Example 84 is the method of any of Examples 79-83, further comprising: overriding, with regard to outputting the packet for transmission, a packet aggregation mechanism, wherein the override is based on the bit associated with the packet being set.

Example 85 is the method of any of Examples 78-84, further comprising: monitoring at least one radio bearer used by the wireless node, wherein the detected latency is further associated with the at least one radio bearer, and wherein the packet was obtained or is to be output for transmission via the at least one radio bearer or another radio bearer associated with the at least one radio bearer.

Example 86 is the method of Example 85, wherein the latency associated with the packet is detected based on a function of: (1) a guaranteed bit rate (GBR) or a prioritized bit rate (PBR) associated with the at least one radio bearer, and (ii) an actual data throughput of the at least one radio bearer, satisfying a threshold condition.

Example 87 is the method of any of Examples 85 and 86, wherein the latency associated with the packet is detected based on a queueing time for packets at the at least one radio bearer satisfying a threshold condition.

Example 88 is the method of any of Examples 78-87, further comprising: combining, via a packet aggregation mechanism, the packet with another packet to form an aggregated package; and setting a bit associated with the aggregated package to indicate a ratio of packets within the package having the bit set.

Example 89 is the method of Example 88, wherein the packet corresponds to a first traffic flow of a plurality of traffic flows associated with a multi-modal extended reality (XR), wherein the detected latency associated with the packet is a latency of a second traffic flow of the plurality of flows, and wherein the bit is set based on at least one of: (i) the detected latency of the second flow, or (ii) the first traffic flow and the second traffic flow being associated with the multi-modal XR.

Example 90 is the method of any of Examples 88 and 89, wherein the packet is a downlink packet, and wherein the latency is detected based on a ratio of: (i) a rate of receiving downlink packets at the wireless node, and (ii) a rate of transmitting uplink packets from the wireless node, and wherein the bit is set based on the rate of receiving downlink packets being less than the rate of receiving uplink packets.

Example 91 is the method of any of Examples 88-90, further comprising: overriding a protocol data unit (PDU) metric configured to drop the packet prior to outputting the packet for transmission.

Example 92 is the method of Example 91, wherein the PDU metric comprises at least one of: packet set delay budget (PSDB), a PDU set error rate (PSER), a PDU set importance (PSI), or a PDU set integrated handling information (PSIHI).

Example 93 is the method of any of Examples 78-92, wherein the latency associated with the packet is detected based on a packet loss detected over a link between the wireless node and a distribution unit (DU), wherein the packet is associated with the link.

Example 94 is the method of Example 93, wherein the link is a new radio unlicensed (NR-U) link.

Example 95 is the method of any of Examples 78-94, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 96 is the method of any of Examples 78-95, further comprising: obtaining, at a first time, N packets including the packet, wherein N is less than a number of packets expected at the first time, wherein the latency associated with the packet is detected based on N being less than the number of packets expected at the first time.

Example 97 is the method of Example 96, wherein an integrity metric associated with the N packets indicates that Nis an acceptable number of packets.

Example 98 is the method of any of Examples 78-97, further comprising: obtaining a plurality of packets including the packet, wherein the plurality of packets are obtained via a multi-modal flow associated with another multi-modal flow, and wherein the latency associated with the packet is detected based on a delay of one or more packets associated with the other multi-modal flow.

Example 99 is the method of any of Examples 78-98, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 100 is the method of any of Examples 78-99, further comprising: obtaining a first plurality of packets, wherein the first plurality of packets comprises fewer packets than expected by the wireless node; obtaining an indication that the first plurality of packets will comprise fewer packets than expected by the wireless node; and obtaining a second plurality of packets comprising the packet, wherein the latency is detected based on at least one of: (i) the first plurality of packets comprising fewer packets than expected by the wireless node, or (ii) the indication that the first plurality of packets will comprise fewer packets than expected by the wireless node.

Example 101 is the method of any of Examples 78-100, wherein the latency associated with the packet is detected based on a duration of time that the packet is queued satisfying a threshold condition.

Example 102 is a method at a wireless node, comprising: detecting latency associated with one or more packets of a plurality of packets queued at the wireless node; and generating meta-data associated with the packet, wherein the meta-data is configured to indicate setting a bit associated with the packet to indicate the detected latency.

Example 103 is the method of Example 102, wherein the bit is associated with an explicit congestion notification (ECN) field of the packet.

Example 104 is the method of any of Examples 102 and 103, wherein the bit is set at one or more of: an application processor, an interconnect between the application processor and a modem, or the modem.

Example 105 is the method of any of Examples 102-104, further comprising: monitoring at least one radio bearer used by the wireless node, wherein the detected latency is further associated with the at least one radio bearer, and wherein the packet was obtained or is to be output for transmission via the at least one radio bearer or another radio bearer associated with the at least one radio bearer.

Example 106 is the method of Example 105, wherein the latency associated with the packet is detected based on a function of: (1) a guaranteed bit rate (GBR) or a prioritized bit rate (PBR) associated with the at least one radio bearer, and (ii) an actual data throughput of the at least one radio bearer, satisfying a threshold condition.

Example 107 is the method of Examples 105 and 106, wherein the latency associated with the packet is detected based on a queueing time for packets at the at least one radio bearer satisfying a threshold condition.

Example 108 is the method of any of Examples 102-107, further comprising: overriding, with regard to outputting the packet for transmission, an aggregated ACK feedback mechanism, wherein the override is based on the set bit associated with the packet.

Example 109 is the method of any of Examples 102-108, further comprising: overriding, with regard to outputting the packet for transmission, a packet shaping mechanism, wherein the override is based on the set bit associated with the packet.

Example 110 is the method of any of Examples 102-109, further comprising: overriding, with regard to outputting the packet for transmission, a packet aggregation mechanism, wherein the override is based on the set bit associated with the packet.

Example 111 is the method of any of Examples 102-110, further comprising: combining, via a packet aggregation mechanism, the packet with another packet to form an aggregated package; and setting a bit associated with the aggregated package to indicate a ratio of packets within the package having the bit set.

Example 112 is the method of any of Examples 102-111, wherein the packet corresponds to a first traffic flow of a plurality of traffic flows associated with a multi-modal extended reality (XR), wherein the detected latency associated with the packet is a latency of a second traffic flow of the plurality of flows, and wherein the bit is set based on at least one of: (i) the detected latency of the second flow, or (ii) the first traffic flow and the second traffic flow being associated with the multi-modal XR.

Example 113 is the method of any of Examples 102-112, further comprising: overriding a protocol data unit (PDU) metric configured to drop the packet prior to outputting the packet for transmission.

Example 114 is the method of Example 113, wherein the PDU metric comprises at least one of: packet set delay budget (PSDB), a PDU set error rate (PSER), a PDU set importance (PSI), or a PDU set integrated handling information (PSIHI).

Example 115 is the method of any of Examples 102-114, wherein the packet is a downlink packet, and wherein the latency is detected based on a ratio of: (i) a rate of receiving downlink packets at the wireless node, and (ii) a rate of transmitting uplink packets from the wireless node, and wherein the bit is set based on the rate of receiving downlink packets being less than the rate of receiving uplink packets.

Example 116 is the method of any of Examples 102-115, wherein the latency associated with the packet is detected based on a packet loss detected over a link between the wireless node and a distribution unit (DU), wherein the packet is associated with the link.

Example 117 is the method of Example 116, wherein the link is a new radio unlicensed (NR-U) link.

Example 118 is the method of any of Examples 102-117, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 119 is the method of any of Examples 102-118, further comprising: obtaining, at a first time, N packets including the packet, wherein N is less than a number of packets expected at the first time, wherein the latency associated with the packet is detected based on N being less than the number of packets expected at the first time.

Example 120 is the method of Example 119, wherein an integrity metric associated with the N packets indicates that Nis an acceptable number of packets.

Example 121 is the method of any of Examples 102-120, further comprising: obtaining a plurality of packets including the packet, wherein the plurality of packets are obtained via a multi-modal flow associated with another multi-modal flow, and wherein the latency associated with the packet is detected based on a delay of one or more packets associated with the other multi-modal flow.

Example 122 is the method of any of Examples 102-121, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 123 is the method of any of Examples 102-122, further comprising: obtaining a first plurality of packets, wherein the first plurality of packets comprises fewer packets than expected by the wireless node; obtaining an indication that the first plurality of packets will comprise fewer packets than expected by the wireless node; and obtaining a second plurality of packets comprising the packet, wherein the latency is detected based on at least one of: (i) the first plurality of packets comprising fewer packets than expected by the wireless node, or (ii) the indication that the first plurality of packets will comprise fewer packets than expected by the wireless node.

Example 124 is the method of any of Examples 102-123, wherein the latency associated with the packet is detected based on a duration of time that the packet is queued satisfying a threshold condition.

Example 125 is a method at a wireless node, comprising: detecting latency associated with a packet queued at the wireless node; and generating a packet data unit (PDU) associated with the packet, wherein the PDU is configured to indicate the detected latency associated with the packet.

Example 126 is the method of Example 125, further comprising: monitoring at least one radio bearer used by the wireless node, wherein the detected latency is further associated with the at least one radio bearer, and wherein the packet was obtained or is to be output for transmission via the at least one radio bearer or another radio bearer associated with the at least one radio bearer.

Example 127 is the method of any of Examples 125 and 126, wherein the latency associated with the packet is detected based on a function of: (1) a guaranteed bit rate (GBR) or a prioritized bit rate (PBR) associated with at least one radio bearer, and (ii) an actual data throughput of the at least one radio bearer, satisfying a threshold condition.

Example 128 is the method of any of Examples 125-127, wherein the latency associated with the packet is detected based on a queueing time for packets of at least one radio bearer satisfying a threshold condition.

Example 129 is the method of any of Examples 125-128, further comprising: combining, via a packet aggregation mechanism, the packet with another packet to form an aggregated package; and setting a bit associated with the aggregated package to indicate a ratio of packets within the package having the bit set.

Example 130 is the method of Example 129, wherein the bit is associated with an explicit congestion notification (ECN) field of the packet.

Example 131 is the method of any of Examples 129 and 130, wherein the bit is set at one or more of: an application processor, an interconnect between the application processor and a modem, or the modem.

Example 132 is the method of any of Examples 129-131, further comprising: overriding, with regard to outputting the packet for transmission, an aggregated ACK feedback mechanism, wherein the override is based on the set bit associated with the packet.

Example 133 is the method of any of Example 129-132, further comprising: overriding, with regard to outputting the packet for transmission, a packet shaping mechanism, wherein the override is based on the set bit associated with the packet.

Example 134 is the method of any of Examples 129-133, further comprising: overriding, with regard to outputting the packet for transmission, a packet aggregation mechanism, wherein the override is based on the set bit associated with the packet.

Example 135 is the method of any of Examples 125-134, wherein the packet corresponds to a first traffic flow of a plurality of traffic flows associated with a multi-modal extended reality (XR), wherein the detected latency associated with the packet is a latency of a second traffic flow of the plurality of flows, and wherein the bit is set based on at least one of: (i) the detected latency of the second flow, or (ii) the first traffic flow and the second traffic flow being associated with the multi-modal XR.

Example 136 is the method of Example 125-135, further comprising: overriding a protocol data unit (PDU) metric configured to drop the packet prior to outputting the packet for transmission.

Example 137 is the method of Example 136, wherein the PDU metric comprises at least one of: packet set delay budget (PSDB), a PDU set error rate (PSER), a PDU set importance (PSI), or a PDU set integrated handling information (PSIHI).

Example 138 is the method of any of Examples 125-137, wherein the packet is a downlink packet, and wherein the latency is detected based on a ratio of: (i) a rate of receiving downlink packets at the wireless node, and (ii) a rate of transmitting uplink packets from the wireless node, and wherein a bit is set based on the rate of receiving downlink packets being less than the rate of receiving uplink packets.

Example 139 is the method of any of Examples 125-138, wherein the latency associated with the packet is detected based on a packet loss detected over a link between the wireless node and a distribution unit (DU), wherein the packet is associated with the link.

Example 140 is the method of Example 139, wherein the link is a new radio unlicensed (NR-U) link.

Example 141 is the method of any of Examples 125-140, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 142 is the method of any of Examples 125-141, further comprising: obtaining, at a first time, N packets including the packet, wherein N is less than a number of packets expected at the first time, wherein the latency associated with the packet is detected based on N being less than the number of packets expected at the first time.

Example 143 is the method of Example 142, wherein an integrity metric associated with the N packets indicates that Nis an acceptable number of packets.

Example 144 is the method of any of Examples 125-143, further comprising: obtaining a plurality of packets including the packet, wherein the plurality of packets are obtained via a multi-modal flow associated with another multi-modal flow, and wherein the latency associated with the packet is detected based on a delay of one or more packets associated with the other multi-modal flow.

Example 145 is the method of any of Examples 125-144, further comprising: obtaining a plurality of packets including the packet, wherein the plurality of packets forms multiple consecutive I-frames, wherein the latency associated with the packet is detected based on the obtained plurality of packets forming multiple consecutive I-frames.

Example 146 is the method of any of Examples 125-145, further comprising: obtaining a first plurality of packets, wherein the first plurality of packets comprises fewer packets than expected by the wireless node; obtaining an indication that the first plurality of packets will comprise fewer packets than expected by the wireless node; and obtaining a second plurality of packets comprising the packet, wherein the latency is detected based on at least one of: (i) the first plurality of packets comprising fewer packets than expected by the wireless node, or (ii) the indication that the first plurality of packets will comprise fewer packets than expected by the wireless node.

Example 147 is the method of any of Examples 125-146, wherein the latency associated with the packet is detected based on a duration of time that the packet is queued satisfying a threshold condition.

Example 148 is an apparatus for wireless communications, comprising means for performing a method in accordance with any one of examples 1-23.

Example 149 is an apparatus for wireless communications, comprising means for performing a method in accordance with any one of examples 24-50.

Example 150 is an apparatus for wireless communications, comprising means for performing a method in accordance with any one of examples 51-77.

Example 151 is an apparatus for wireless communications, comprising means for performing a method in accordance with any one of examples 78-101.

Example 152 is an apparatus for wireless communications, comprising means for performing a method in accordance with any one of examples 102-124.

Example 153 is an apparatus for wireless communications, comprising means for performing a method in accordance with any one of examples 125-147.

Example 154 is a non-transitory computer-readable medium comprising instructions that, when executed by a wireless node, cause the wireless node to perform a method in accordance with any one of examples 1-23.

Example 155 is a non-transitory computer-readable medium comprising instructions that, when executed by a wireless node, cause the wireless node to perform a method in accordance with any one of examples 24-50.

Example 156 is a non-transitory computer-readable medium comprising instructions that, when executed by a wireless node, cause the wireless node to perform a method in accordance with any one of examples 51-77.

Example 157 is a non-transitory computer-readable medium comprising instructions that, when executed by a wireless node, cause the wireless node to perform a method in accordance with any one of examples 78-101.

Example 158 is a non-transitory computer-readable medium comprising instructions that, when executed by a wireless node, cause the wireless node to perform a method in accordance with any one of examples 102-124.

Example 159 is a non-transitory computer-readable medium comprising instructions that, when executed by a wireless node, cause the wireless node to perform a method in accordance with any one of examples 125-147.

Example 160 is an apparatus for wireless communications, comprising: one or more memories, individually or in combination, having instructions; and one or more processors, individually or in combination, configured to execute the instructions to cause the apparatus to perform a method in accordance with any one of examples 1-23.

Example 161 is an apparatus for wireless communications, comprising: one or more memories, individually or in combination, having instructions; and one or more processors, individually or in combination, configured to execute the instructions to cause the apparatus to perform a method in accordance with any one of examples 24-50.

Example 162 is an apparatus for wireless communications, comprising: one or more memories, individually or in combination, having instructions; and one or more processors, individually or in combination, configured to execute the instructions to cause the apparatus to perform a method in accordance with any one of examples 51-77.

Example 163 is an apparatus for wireless communications, comprising: one or more memories, individually or in combination, having instructions; and one or more processors, individually or in combination, configured to execute the instructions to cause the apparatus to perform a method in accordance with any one of examples 78-101.

Example 164 is an apparatus for wireless communications, comprising: one or more memories, individually or in combination, having instructions; and one or more processors, individually or in combination, configured to execute the instructions to cause the apparatus to perform a method in accordance with any one of examples 102-124

Example 165 is an apparatus for wireless communications, comprising: one or more memories, individually or in combination, having instructions; and one or more processors, individually or in combination, configured to execute the instructions to cause the apparatus to perform a method in accordance with any one of examples 125-147.

Example 166 is a wireless node (e.g., user equipment (UE) or network entity), comprising: one or more transceivers; one or more memories, individually or in combination, having instructions; and one or more processors, individually or in combination, configured to execute the instructions to cause the wireless node to perform a method in accordance with any one of examples 1-23.

Example 167 is a wireless node (e.g., user equipment (UE) or network entity), comprising: one or more transceivers; one or more memories, individually or in combination, having instructions; and one or more processors, individually or in combination, configured to execute the instructions to cause the wireless node to perform a method in accordance with any one of examples 24-50.

Example 168 is a wireless node (e.g., user equipment (UE) or network entity), comprising: one or more transceivers; one or more memories, individually or in combination, having instructions; and one or more processors, individually or in combination, configured to execute the instructions to cause the wireless node to perform a method in accordance with any one of examples 51-77, wherein the one or more transceivers are configured to: transmit the plurality of packets; and receive the aggregated ACK.

Example 169 is a wireless node (e.g., user equipment (UE) or network entity), comprising: one or more transceivers; one or more memories, individually or in combination, having instructions; and one or more processors, individually or in combination, configured to execute the instructions to cause the wireless node to perform a method in accordance with any one of examples 78-101.

Example 170 is a wireless node (e.g., user equipment (UE) or network entity), comprising: one or more transceivers; one or more memories, individually or in combination, having instructions; and one or more processors, individually or in combination, configured to execute the instructions to cause the wireless node to perform a method in accordance with any one of examples 102-124.

Example 171 is a wireless node (e.g., user equipment (UE) or network entity), comprising: one or more transceivers; one or more memories, individually or in combination, having instructions; and one or more processors, individually or in combination, configured to execute the instructions to cause the wireless node to perform a method in accordance with any one of examples 125-147.

What is claimed is:

1. An apparatus for wireless communication, comprising:
one or more memories, individually or in combination, having instructions; and
one or more processors, individually or in combination, configured to execute the instructions and cause the apparatus to:
detect latency associated with a packet queued at the apparatus; and
modify a reordering timer associated with the packet after latency associated with the packet is detected.

2. The apparatus of claim 1, wherein the one or more processors, individually or in combination, are further configured to cause the apparatus to:
refrain, for a duration of time, from coalescing the packet based on the detected latency.

3. The apparatus of claim 1, wherein the one or more processors, individually or in combination, are further configured to cause the apparatus to:
set a bit associated with the packet to indicate the detected latency, wherein the bit is set at a data layer of the apparatus.

4. The apparatus of claim 3, wherein the one or more processors, individually or in combination, are further configured to cause the apparatus to:
obtain a plurality of packets including the packet, wherein the plurality of packets forms multiple consecutive I-frames, wherein the latency associated with the packet is detected based on the obtained plurality of packets forming multiple consecutive I-frames.

5. The apparatus of claim 3, wherein the one or more processors, individually or in combination, are further configured to cause the apparatus to:
obtain, at a first time, N packets including the packet, wherein N is less than a number of packets expected at the first time, wherein the latency associated with the packet is detected based on N being less than the number of packets expected at the first time, wherein an integrity metric associated with the N packets indicates that N is an acceptable number of packets.

6. The apparatus of claim 3, wherein the one or more processors, individually or in combination, are further configured to cause the apparatus to:
obtain a plurality of packets including the packet, wherein the plurality of packets are obtained via a multi-modal flow associated with another multi-modal flow, and wherein the latency associated with the packet is detected based on a delay of one or more packets associated with the other multi-modal flow.

7. The apparatus of claim 3, wherein the one or more processors, individually or in combination, are further configured to cause the apparatus to:
obtain a first plurality of packets, wherein the first plurality of packets comprises fewer packets than expected by the apparatus;
obtain an indication that the first plurality of packets will comprise fewer packets than expected by the apparatus; and
obtain a second plurality of packets comprising the packet, wherein the latency is detected based on at least one of: (i) the first plurality of packets comprising fewer packets than expected by the apparatus, or (ii) the indication that the first plurality of packets will comprise fewer packets than expected by the apparatus.

8. The apparatus of claim 3, wherein the latency associated with the packet is detected based on a duration of time that the packet is queued satisfying a threshold condition.

9. The apparatus of claim 1, wherein the one or more processors, individually or in combination, are further configured to cause the apparatus to:
generate meta-data associated with the packet, wherein the meta-data is configured to indicate setting a bit associated with the packet to indicate the detected latency.

10. The apparatus of claim 9, wherein the packet is a PDCP layer packet, and wherein the one or more processors, individually or in combination, are further configured to cause the apparatus to:
extract an IP packet from the PDCP layer packet.

11. The apparatus of claim 1, wherein packet comprises a bit associated with an explicit congestion notification (ECN) field of the packet, and wherein the latency associated with the packet is detected based on the bit.

12. The apparatus of claim 1, wherein the reordering timer comprises a packet data convergence protocol (PDCP) reordering timer.

13. The apparatus of claim 1, wherein the reordering timer is modified at a bearer level, an application flow level, or a quality of service (QOS) flow level.

14. The apparatus of claim 1, wherein the reordering timer is modified based on the detected latency associated with the packet and a type of traffic associated with the packet.

15. The apparatus of claim 14, wherein the type of traffic comprises low latency, low loss, and scalable throughput (LAS) type traffic and non-LAS type traffic, and wherein the reordering timer is modified based on the type of traffic associated with the packet being LAS type traffic.

16. An apparatus for wireless communication, comprising:
one or more memories, individually or in combination, having instructions; and
one or more processors, individually or in combination, configured to execute the instructions and cause the apparatus to:
output a plurality of packets;
obtain, after outputting the plurality of packets, an aggregated acknowledgment (ACK) comprising an indication of a latency associated with at least one of the plurality of packets; and
refrain, for a duration of time, from dropping a packet associated with the aggregated ACK based on the indication of the latency.

17. The apparatus of claim 16, wherein the one or more processors, individually or in combination, being configured to refrain from dropping the packet associated with the aggregated ACK, are further configured to cause the apparatus to:
override a configuration configured to cause the apparatus to drop one or more packets associated with aggregated ACKs.

18. The apparatus of claim 16, wherein the indication of the latency comprises an explicit congestion notification (ECN) field of at least one of the plurality of packets.

19. An apparatus for wireless communication, comprising:
one or more memories, individually or in combination, having instructions; and
one or more processors, individually or in combination, configured to execute the instructions and cause the apparatus to:
detect latency associated with a packet queued at the apparatus; and
set a bit associated with the packet to indicate the detected latency, wherein the bit is set at a data layer of the apparatus.

20. The apparatus of claim 19, wherein the bit is set at one or more of: an application processor, an interconnect between the application processor and a modem, or the modem.
